(19) United States
(12) Patent Application Publication
(10) Pub. No.: US 2026/0120617 A1
(43) Pub. Date: Apr. 30, 2026

(54) DRIVING CIRCUIT AND ELECTRONIC DEVICE HAVING THE SAME

(71) Applicant: Samsung Display Co., Ltd., Yongin-si (KR)

(72) Inventors: JONGMAN BAE, Yongin-si (KR); CHAEHEE PARK, Yongin-si (KR); WOO-CHUL KIM, Yongin-si (KR); JINYOUNG JEON, Yongin-si (KR)

(21) Appl. No.: 19/240,495

(22) Filed: Jun. 17, 2025

(30) Foreign Application Priority Data
Oct. 25, 2024 (KR) 10-2024-0147228

(51) Int. Cl. G09G 3/20; G06F 3/147; G09G 3/32

(52) U.S. Cl. CPC G09G 3/2096; G06F 3/147; G09G 3/32; G09G 2300/0819; G09G 2300/0842; G09G 2300/0861; G09G 2330/023; G09G 2340/0435; G09G 2370/04

(57) ABSTRACT

An electronic device includes a display panel, a processor for outputting a transmission signal, and a driving circuit for receiving the transmission signal and outputting a data signal such that an image is displayed on the display panel based on the transmission signal. When a current image corresponding to a first part of the display panel is different from a previous image corresponding to the first part of the display panel and the processor does not receive a refresh request signal from the driving circuit, the processor outputs the transmission signal corresponding to the first part of the display panel. When a display time of a still image displayed on a second part of the display panel reaches a preset time, the driving circuit transmits the refresh request signal to the processor. The processor outputs the transmission signal including the still image in response to the refresh request signal.

This application claims priority to Korean Patent Application No. 10-2024-0147228 filed on Oct. 25, 2024, and all the benefits accruing therefrom under 35 U.S.C. § 119, the content of which in its entirety is herein incorporated by reference.

### BACKGROUND

Embodiments of the present disclosure described herein relate to a driving circuit and an electronic device including the same.

An electronic device includes pixels connected to data lines and scan lines. Each of the pixels includes a light emitting element and a pixel circuit for controlling the light emitting element. The pixel circuit may provide a current corresponding to a data signal to the light emitting element. In this case, light having predetermined luminance may be generated in response to a current flowing through the light emitting element.

One method for improving the display quality of an image displayed on the electronic device is to increase the operating frequency of the electronic device. In the meantime, one method for reducing the power consumption of the electronic devices is to lower the operating frequency of the electronic device.

### SUMMARY

Embodiments of the present disclosure provide an electronic device capable of operating at various driving frequencies.

According to an embodiment, an electronic device includes a display panel, a processor that outputs a transmission signal, and a driving circuit that receives the transmission signal and outputs a data signal such that an image is displayed on the display panel based on the transmission signal. When a current image corresponding to a first part of the display panel is different from a previous image corresponding to the first part of the display panel and the processor does not receive a refresh request signal from the driving circuit, the processor outputs the transmission signal, which corresponds to the first part of the display panel and does not include a still image displayed on a second part of the display panel. When a display time of the still image displayed on the second part of the display panel reaches a preset time, the driving circuit transmits the refresh request signal to the processor. The processor outputs the transmission signal including the still image in response to the refresh request signal.

In an embodiment, when the transmission signal corresponding to the first part of the display panel is received, the driving circuit may output the data signal corresponding to the first part of the display panel to the display panel.

In an embodiment, the processor may output the transmission signal corresponding to a full image to be displayed on an entire display area of the display panel in response to the refresh request signal.

In an embodiment, the full image may include a video corresponding to the first part of the display panel and the still image corresponding to the second part of the display panel.

In an embodiment, the processor and the driving circuit may operate in a single frequency mode and a multi-frequency mode. In the single frequency mode, the entire display panel may be driven at an identical frequency. In the multi-frequency mode, a first display area of the display panel may be driven at a first operating frequency, and a second display area corresponding to the first part of the display panel is driven at a second operating frequency different from the first operating frequency.

In an embodiment, when the transmission signal corresponding to the first display area of the display panel is received, the driving circuit may output the data signal corresponding to the first display area of the display panel. When the transmission signal corresponding to the second display area of the display panel is received, the driving circuit may output the data signal corresponding to the second display area of the display panel.

In an embodiment, when an operating mode is changed from the single frequency mode to the multi-frequency mode, the processor may output the transmission signal corresponding to a full image to be displayed on an entire display area of the display panel in a first frame of the multi-frequency mode.

In an embodiment, the driving circuit may include a driving controller that receives the transmission signal and outputs an image data signal and an emission control signal based on the transmission signal, and a data driving circuit that outputs a data signal corresponding to the image data signal to the display panel.

In an embodiment, the driving controller may include a counter circuit that outputs a first count signal and a second count signal corresponding to the first display area and the second display area, respectively, in synchronization with the emission control signal. When at least one of the first count signal and the second count signal reaches a preset value, the driving controller may transmit the refresh request signal to the processor.

In an embodiment, the driving controller may reset the first count signal of the counter circuit to ‘0’ when the transmission signal corresponding to the first display area is received, and may reset the second count signal of the counter circuit to ‘0’, when the transmission signal corresponding to the second display area is received.

In an embodiment, when a size of at least one of the first display area and the second display area is changed, the processor may output the transmission signal corresponding to a full image of the display panel.

According to an embodiment, an electronic device includes a display panel, a processor that outputs a transmission signal, and a driving circuit that receives the transmission signal and outputs a data signal such that an image is displayed on the display panel based on the transmission signal. In a multi-frequency mode, the processor divides the display panel into a first display area, where a still image is displayed, and a second display area, where a video is displayed, and outputs the transmission signal corresponding to only the second display area of the first and second display areas. In the multi-frequency mode, the driving circuit transmits a refresh request signal to the processor when a display time of the still image displayed in the first display area of the display panel reaches a preset time. The processor outputs the transmission signal corresponding to a full image to be displayed on the first and second display areas of the display panel in response to the refresh request signal.

In an embodiment, the processor may output the transmission signal corresponding to the full image of the display panel in a first frame of the multi-frequency mode.

In an embodiment, the driving circuit may include a driving controller that receives the transmission signal and outputs an image data signal and an emission control signal based on the transmission signal, and a data driving circuit that outputs a data signal corresponding to the image data signal to the display panel.

In an embodiment, the driving controller may include a counter circuit that outputs a first count signal and a second count signal corresponding to the first display area and the second display area, respectively, in synchronization with the emission control signal. When at least one of the first count signal and the second count signal reaches a preset value, the driving controller may transmit the refresh request signal to the processor.

In an embodiment, the driving controller may reset the first count signal of the counter circuit to ‘0’ when the transmission signal corresponding to the first display area is received, and may reset the second count signal of the counter circuit to ‘0’, when the transmission signal corresponding to the second display area is received.

In an embodiment, when a size of at least one of the first display area and the second display area is changed, the processor may output the transmission signal corresponding to a full image of the display panel.

According to an embodiment, a driving circuit includes a driving controller that receives a transmission signal and outputs an image data signal and an emission control signal based on the transmission signal, and a data driving circuit that outputs a data signal corresponding to the image data signal to a display panel. The driving controller divides the display panel into a first display area, where a still image is displayed, and a second display area, where a video is displayed, based on the transmission signal. When a display time of the still image reaches a preset time, the driving controller outputs a refresh request signal.

In an embodiment, the driving controller may include a counter circuit that outputs a first count signal and a second count signal corresponding to the first display area and the second display area, respectively, in synchronization with the emission control signal. When at least one of the first count signal and the second count signal reaches a preset value, the driving controller may output the refresh request signal.

In an embodiment, the driving controller may reset the first count signal of the counter circuit to ‘0’ when the transmission signal corresponding to the first display area is received, and may reset the second count signal of the counter circuit to ‘0’, when the transmission signal corresponding to the second display area is received.

### BRIEF DESCRIPTION OF THE FIGURES

The above and other objects and features of the present disclosure will become apparent by describing in detail embodiments thereof with reference to the accompanying drawings.

FIG. 1 shows an electronic device, according to an embodiment of the present disclosure.

FIG. 2 shows an image displayed on an electronic device, according to an embodiment of the present disclosure.

FIGS. 3A and 3B are perspective views of an electronic device, according to an embodiment of the present disclosure.

FIG. 4A is a diagram for describing an operation of an electronic device in a single frequency mode.

FIG. 4B is a diagram for describing an operation of an electronic device in a multi-frequency mode.

FIG. 5 is a block diagram of an electronic device, according to an embodiment of the present disclosure.

FIG. 6 is a circuit diagram of a pixel, according to an embodiment of the present disclosure.

FIG. 7 is a block diagram showing a configuration of a processor and a driving controller of an electronic device.

FIGS. 8A to 8U are drawings showing images displayed on the display panel DP.

FIGS. 9A, 9B, and 9C are drawings for describing an operation of a processor and a driving circuit in a single frequency mode and a multi-frequency mode.

### DETAILED DESCRIPTION

In the specification, the expression that a first component (or region, layer, part, etc.) is “on”, “connected with”, or “coupled with” a second component means that the first component is directly on, connected with, or coupled with the second component or means that a third component is interposed therebetween.

The same sign refers to the same element. Also, in drawings, the thickness, ratio, and dimension of components are exaggerated for effectiveness of description of technical contents. The term “and/or” includes one or more combinations of the associated listed items.

Although the terms “first”, “second”, etc. may be used to describe various components, the components should not be construed as being limited by the terms. The terms are only used to distinguish one component from another component. For example, without departing from the scope and spirit of the present disclosure, a first component may be referred to as a second component, and similarly, the second component may be referred to as the first component. The articles “a,” “an,” and “the” are singular in that they have a single referent, but the use of the singular form in the specification should not preclude the presence of more than one referent.

Also, the terms “under”, “beneath”, “on”, “above”, etc. are used to describe a relationship between components illustrated in a drawing. The terms are relative and are described with reference to a direction indicated in the drawing.

It will be understood that the terms “include”, “comprise”, “have”, etc. specify the presence of features, numbers, steps, operations, elements, or components, described in the specification, or a combination thereof, not precluding the presence or additional possibility of one or more other features, numbers, steps, operations, elements, or components or a combination thereof.

Unless otherwise defined, all terms (including technical terms and scientific terms) used in this specification have the same meaning as commonly understood by those skilled in the art to which the present disclosure belongs. Furthermore, terms such as terms defined in the dictionaries commonly used should be interpreted as having a meaning consistent with the meaning in the context of the related technology, and should not be interpreted in ideal or overly formal meanings unless explicitly defined herein.

Hereinafter, embodiments of the present disclosure will be described with reference to accompanying drawings.

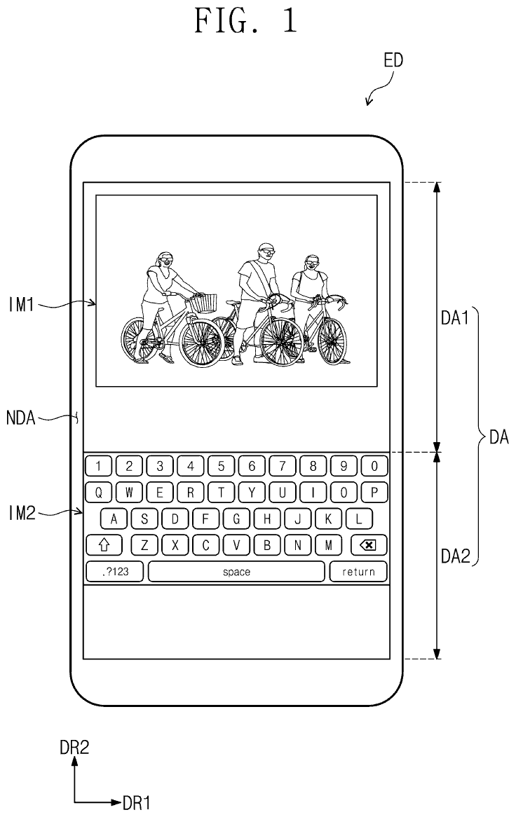

FIG. 1 shows an electronic device ED, according to an embodiment of the present disclosure.

Referring to FIG. 1, a portable terminal is illustrated as an example of the electronic device ED according to an embodiment of the present disclosure. The portable terminal may include a tablet PC, a smartphone, a personal digital assistant (PDA), a portable multimedia player (PMP), a game console, a wristwatch-type electronic device, and the like. However, the present disclosure is not limited thereto. The present disclosure may be used for small and medium electronic devices such as a personal computer, a notebook computer, a kiosk, a car navigation unit, and a camera, in addition to large-sized electronic equipment such as a television or an outside billboard. The above examples are provided only as an embodiment, and it is obvious that the present disclosure may be applied to any other electronic device(s) without departing from the concept of the present disclosure.

As shown in FIG. 1, a display surface of the electronic device ED, on which a first image IM1 and a second image IM2 are displayed, is parallel to a plane defined by a first direction DR1 and a second direction DR2. The electronic device ED includes a plurality of areas separated on the display surface. The display surface includes a display area DA, in which the first image IM1 and the second image IM2 are displayed, and a non-display area NDA adjacent to the display area DA. The non-display area NDA may be referred to as a bezel area. For example, the display area DA may have a rectangular shape. The non-display area NDA surrounds the display area DA. Also, although not illustrated, for example, the electronic device ED may include a shape thus partially curved.

The display area DA of the electronic device ED includes a first display area DA1 and a second display area DA2. In a specific application program, the first image IM1 may be displayed on the first display area DA1, and the second image IM2 may be displayed on the second display area DA2. For example, the first image IM1 may be an image having a fast change cycle (e.g., video, that is, moving images), and the second image IM2 may be an image (e.g., a still image such as a photo or text information) having a long change period.

The operating mode of the electronic device ED may include a single frequency mode and a multi-frequency mode. The electronic device ED may drive both the first display area DA1 and the second display area DA2 at a default frequency in the single frequency mode. In the multi-frequency mode, the electronic device ED according to an embodiment may drive the first display area DA1 where the first image IM1 is displayed at a first operating frequency, and may drive the second display area DA2 where the second image IM2 is displayed, at a second operating frequency. In an embodiment, the first operating frequency may be higher than or equal to the default frequency. In an embodiment, the second operating frequency may be lower than the first frequency. The electronic device ED may reduce power consumption by lowering the operating frequency of the second display area DA2.

The size of each of the first display area DA1 and the second display area DA2 may be a preset size, and may be changed by an application program.

In an embodiment, when the still image is displayed in the first display area DA1 and the video is displayed in the second display area DA2, the first display area DA1 may be driven at a frequency lower than the default frequency, and the second display area DA2 may be driven at a frequency higher than or equal to the default frequency.

In an embodiment, the display area DA may be divided into three or more display areas. An operating frequency of each of the display areas may be determined depending on the type (a still image or video) of an image displayed in each of the display areas.

In an embodiment, the electronic device ED may drive both the first display area DA1 and the second display area DA2 at a default frequency in the single frequency mode. In the multi-frequency mode, the electronic device ED may drive either the first display area DA1 or the second display area DA2 at a lower frequency than the default frequency.

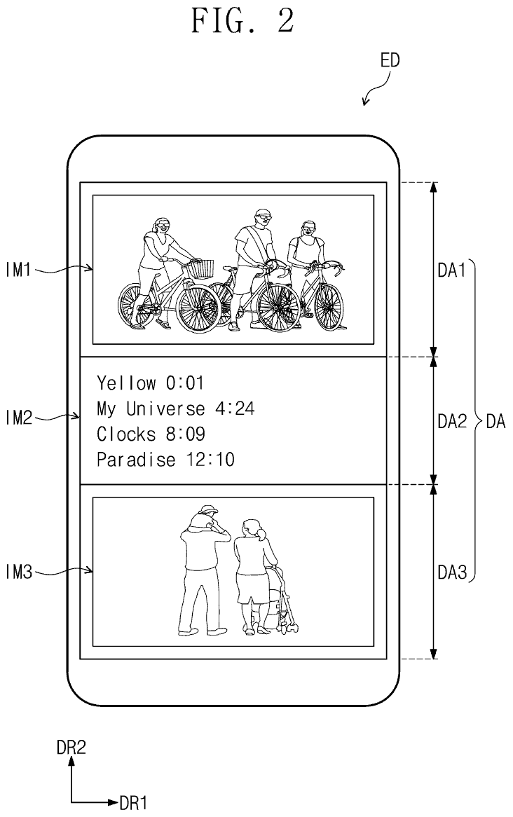

FIG. 2 shows an image displayed on the electronic device ED, according to an embodiment of the present disclosure.

Referring to FIG. 2, the display area DA of the electronic device ED includes a first display area DA1, a second display area DA2, and a third display area DA3.

In a single frequency mode, the electronic device ED may drive all of the first display area DA1, the second display area DA2, and the third display area DA3 at a default frequency.

In a specific application program, the first image IM1 may be displayed on the first display area DA1; the second image IM2 may be displayed on the second display area DA2; and a third image IM3 may be displayed on the third display area DA3. In an embodiment, the first image IM1 and the third image IM3 may be an image (e.g., a video) having a fast change cycle, and the second image IM2 may be an image (e.g., a still image such as a photo or text information) having a long change period. In the case, the electronic device ED may operate in a multi-frequency mode.

In the multi-frequency mode, the electronic device ED according to an embodiment may drive the first display area DA1, where the first image IM1 is displayed, and the third display area DA3, where the third image IM3 is displayed, at a first operating frequency and may drive the second display area DA2, where the second image IM2 is displayed, at a second operating frequency. In an embodiment, the first operating frequency may be higher than or equal to the default frequency. In an embodiment, the second operating frequency may be lower than the first frequency. The electronic device ED may reduce power consumption by lowering the operating frequency of the second display area DA2.

The size of each of the first display area DA1, the second display area DA2, and the third display area DA3 may be a preset size, and may be changed by an application program.

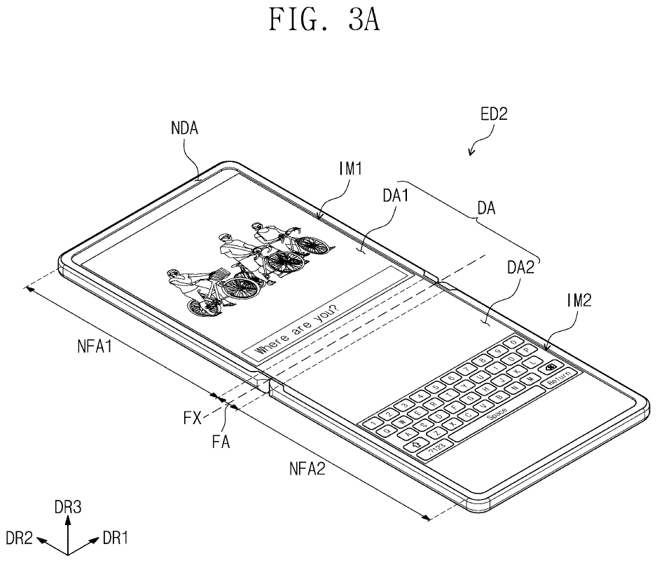

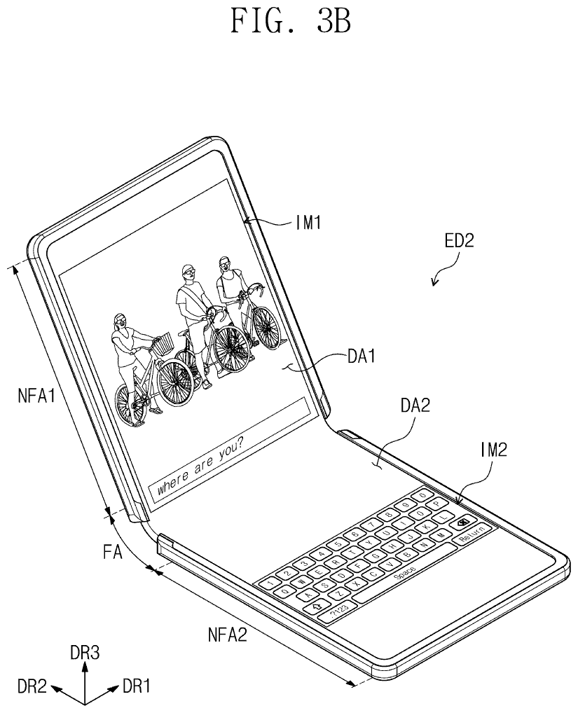

FIGS. 3A and 3B are perspective views of an electronic device ED2, according to an embodiment of the present disclosure. FIG. 3A illustrates that the electronic device ED2 is in an unfolded state. FIG. 3B illustrates that the electronic device ED2 is in a folded state.

As shown in FIGS. 3A and 3B, the electronic device ED2 includes the display area DA and the non-display area NDA. The electronic device ED2 may display an image through the display area DA. The display area DA may include a plane defined by the first direction DR1 and the second direction DR2, in a state where the electronic device ED2 is unfolded. A thickness direction of the electronic device ED2 may be parallel to a third direction DR3 intersecting the first direction DR1 and the second direction DR2. Accordingly, front surfaces (or upper surfaces) and back surfaces (or lower surfaces) of members constituting the electronic device ED2 may be defined based on the third direction DR3. The non-display area NDA may be referred to as a bezel area. For example, the display area DA may have a rectangular shape. The non-display area NDA surrounds the display area DA.

The display area DA may include a first non-folding area NFA1, a folding area FA, and a second non-folding area NFA2. The folding area FA may be bent about a folding axis FX extending in the first direction DR1.

When the electronic device ED2 is folded, the first non-folding area NFA1 and the second non-folding area NFA2 may face each other. Accordingly, while being fully folded, the display area DA may not be exposed to the outside, which may be referred to as “in-folding”. However, embodiments are not limited thereto and the operation of the electronic device ED2 is not limited thereto.

In an embodiment of the present disclosure, when the electronic device ED2 is folded, the first non-folding area NFA1 and the second non-folding area NFA2 may be opposite to each other. Accordingly, while being folded, the first non-folding area NFA1 may be exposed to the outside, which may be referred to as “out-folding”.

The electronic device ED2 may perform only one operation of an in-folding operation or an out-folding operation. Alternatively, the electronic device ED2 may perform both the in-folding operation and the out-folding operation. In this case, the same area of the electronic device ED2, for example, the folding area FA may be folded inwardly and outwardly. Alternatively, some areas of the electronic device ED2 may be folded inwardly, and other areas may be folded outwardly.

One folding area and two non-folding areas are illustrated in FIGS. 3A and 3B, but the number of folding areas and the number of non-folding areas are not limited thereto. For example, the electronic device ED2 may include a plurality of non-folding areas, of which the number is greater than two, and a plurality of folding areas, each of which is interposed between non-folding areas adjacent to one another.

FIGS. 3A and 3B illustrates that the folding axis FX is parallel to the minor axis of the electronic device ED2. However, the present disclosure is not limited thereto. For example, the folding axis FX may extend in a direction parallel to the major axis of the electronic device ED2, for example, the second direction DR2.

FIGS. 3A and 3B illustrate that the first non-folding area NFA1, the folding area FA, and the second non-folding area NFA2 may be sequentially arranged in the second direction DR2. However, the present disclosure is not limited thereto. For example, the first non-folding area NFA1, the folding area FA, and the second non-folding area NFA2 may be sequentially arranged in the first direction DR1.

The plurality of display areas DA1 and DA2 may be defined in the display area DA of the electronic device ED2. FIG. 3A illustrates the two display areas DA1 and DA2 as an example. However, the number of display areas DA1 and DA2 is not limited thereto.

The plurality of display areas DA1 and DA2 may include the first display area DA1 and the second display area DA2. For example, the first display area DA1 may be an area where the first image IM1 is displayed, and the second display area DA2 may be an area in which the second image IM2 is displayed. For example, the first image IM1 may be a video, and the second image IM2 may be a still image.

The electronic device ED2 according to an embodiment may operate differently depending on an operating mode. The operating mode of the electronic device ED2 may include a single frequency mode and a multi-frequency mode.

The electronic device ED2 may drive both the first display area DA1 and the second display area DA2 at a default frequency in the single frequency mode. In the multi-frequency mode, the electronic device ED2 according to an embodiment may drive the first display area DA1 where the first image IM1 is displayed at a first operating frequency, and may drive the second display area DA2 where the second image IM2 is displayed, at a second operating frequency. In an embodiment, the first operating frequency may be higher than or equal to the default frequency. The second operating frequency may be lower than the first operating frequency.

The size of each of the first display area DA1 and the second display area DA2 may be a preset size, and may be changed by an application program. In an embodiment, the first display area DA1 may correspond to the first non-folding area NFA1, and the second display area DA2 may correspond to the second non-folding area NFA2. In addition, a first portion of the folding area FA may correspond to the first display area DA1, and a second portion of the folding area FA may correspond to the second display area DA2.

In an embodiment, the entire folding area FA may correspond to only one of the first display area DA1 and the second display area DA2.

In an embodiment, the first display area DA1 may correspond to the first portion of the first non-folding area NFA1, and the second display area DA2 may correspond to the second portion of the first non-folding area NFA1, the folding area FA, and the second non-folding area NFA2. That is, the size of the second display area DA2 may be greater than the size of the first display area DA1.

In an embodiment, the first display area DA1 may correspond to the first non-folding area NFA1, the folding area FA, and the first portion of the second non-folding area NFA2, and the second display area DA2 may be the second portion of the second non-folding area NFA2. That is, the size of the first display area DA1 may be greater than the size of the second display area DA2.

As illustrated in FIG. 3B, in a state where the folding area FA is folded, the first display area DA1 may correspond to the first non-folding area NFA1, and the second display area DA2 may correspond to the folding area FA and the second non-folding area NFA2.

FIGS. 3A and 3B illustrates that the electronic device ED2 has one folding area, as an example of an electronic device. However, the present disclosure is not limited thereto. For example, the present disclosure may also be applied to an electronic device having two or more folding areas, a rollable electronic device, or a slidable electronic device.

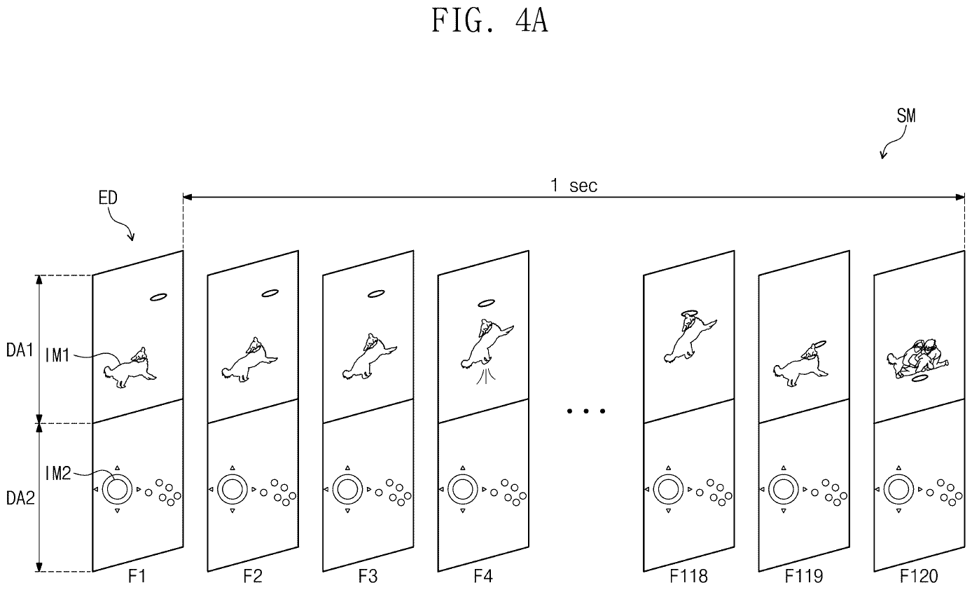

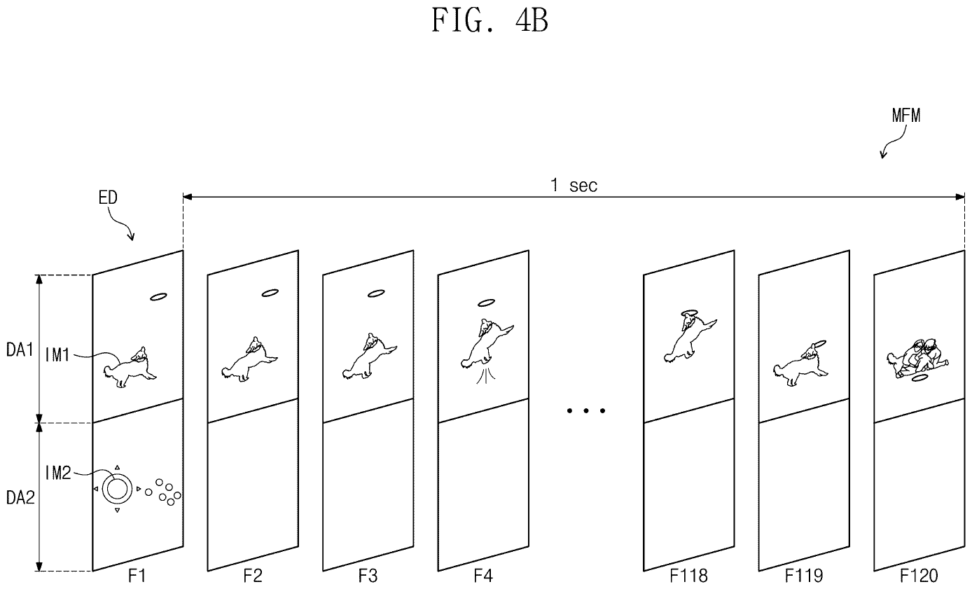

FIG. 4A is a diagram for describing an operation of the electronic device ED in a single frequency mode.

FIG. 4B is a diagram for describing an operation of the electronic device ED in a multi-frequency mode.

Referring to FIG. 4A, the first image IM1 displayed in the first display area DA1 may be a video. The second image IM2 displayed in the second display area DA2 may be a still image or an image (e.g., a keypad image for manipulating a game) having a long change period. The first image IM1 displayed in the first display area DA1 and the second image IM2 displayed in the second display area DA2 that are shown in FIG. 4A are examples, and various images may be displayed on the electronic device ED.

In a single frequency mode SM, the operating frequency of the first display area DA1 and the second display area DA2 of the electronic device ED is a default frequency. For example, the default frequency may be 120 Hz. In the single frequency mode SM, images of first to 120th frames F1 to F120 may be sequentially displayed in the first display area DA1 and the second display area DA2 of the electronic device ED for one second.

Referring to FIG. 4B, in a multi-frequency mode MFM, the electronic device ED may set an operating frequency of the first display area DA1, in which the first image IM1 (i.e., a video) is displayed, as the first operating frequency, and may set an operating frequency of the second display area DA2, in which the second image IM2 (i.e., a still image) is displayed, as a second operating frequency lower than the first operating frequency. The first operating frequency may be 120 Hz, and the second operating frequency may be 1 Hz. The first operating frequency and the second operating frequency may be variously changed.

In the multi-frequency mode MFM, when the first operating frequency is 120 Hz and the second operating frequency is 1 Hz, a data signal corresponding to the first image IM1 may be provided in the first display area DA1 of the electronic device ED for one second in each of the first to 120th frames F1 to F120. A data signal corresponding to the second image IM2 may be provided to the second display area DA2 during only the first frame F1. That is, because a new data signal is not provided to the second display area DA2 during the second to 120th frames F2 to F120, the second image IM2 the same as the second image IM2 during the first frame F1 may be displayed on the electronic device ED during the second to 120th frames F2 to F120.

FIG. 4B illustrates that, in the multi-frequency mode MFM, the first operating frequency is 120 Hz and the second operating frequency is 1 Hz, but the present disclosure is not limited thereto. The second operating frequency may be variously changed to a frequency lower than the first operating frequency, for example, 60 Hz, 30 Hz, 10 Hz, or the like.

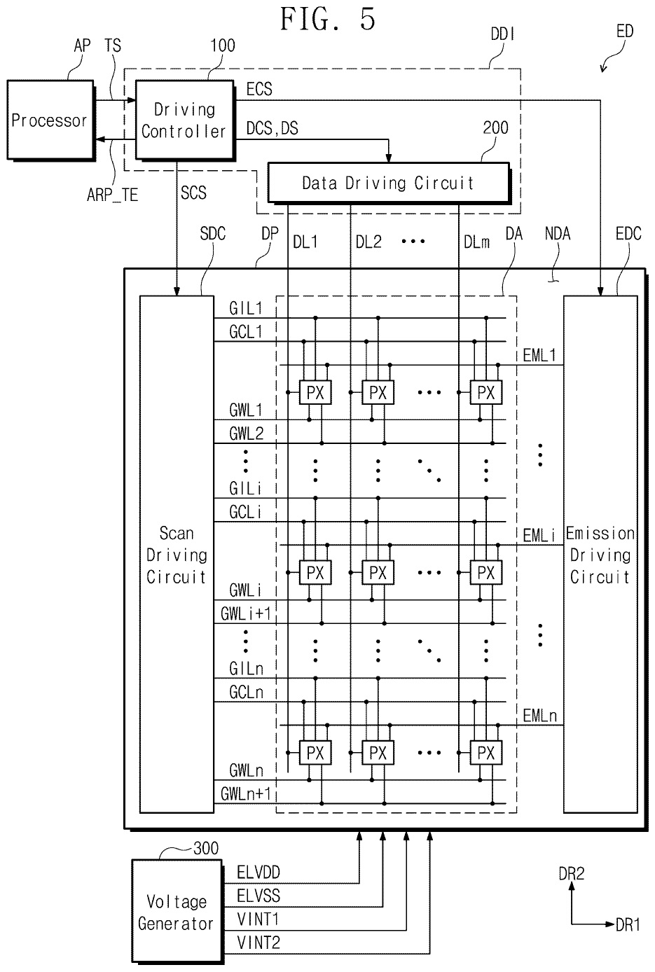

FIG. 5 is a block diagram of the electronic device ED, according to an embodiment of the present disclosure.

Referring to FIG. 5, the electronic device ED includes a processor AP, a driving circuit DDI, a display panel DP, and a voltage generator 300.

The processor AP may be one of an application processor, a graphic processor, a main processor, or a central processing unit (CPU). The driving circuit DDI includes a driving controller 100 and a data driving circuit 200. In an embodiment, the driving controller 100 and the data driving circuit 200 may be implemented in one chip, but the present disclosure is not limited thereto.

The processor AP provides a transmission signal TS to the driving controller 100.

The driving controller 100 operates in response to the transmission signal TS from the processor AP. The driving controller 100 converts the image signal included in the transmission signal TS into an image data signal DS and outputs the image data signal DS. The driving controller 100 outputs a scan control signal SCS, a data control signal DCS, and an emission control signal ECS in response to a control signal included in the transmission signal TS.

The data driving circuit 200 receives the data control signal DCS and the image data signal DS from the driving controller 100. The data driving circuit 200 converts the image data signal DS into data signals and then outputs the data signals to a plurality of data lines DL1 to DLm to be described later.

The voltage generator 300 generates voltages necessary to operate the display panel DP. In an embodiment, the voltage generator 300 generates a first driving voltage ELVDD, a second driving voltage ELVSS, a first initialization voltage VINT1, and a second initialization voltage VINT2.

The display panel DP includes scan lines GIL1 to GILn, GCL1 to GCLn, and GWL1 to GWLn+1, emission control lines EML1 to EMLn, the data lines DL1 to DLm, and pixels PX. The display panel DP may further include a scan driving circuit SDC and an emission driving circuit EDC. In an embodiment, the scan driving circuit SDC is arranged on a first side of the display panel DP. The scan lines GIL1 to GILn, GCL1 to GCLn, and GWL1 to GWLn+1 extend from the scan driving circuit SDC in the first direction DR1.

The emission driving circuit EDC is arranged on a second side of the display panel DP. The emission control lines EML1 to EMLn extend from the emission driving circuit EDC in a direction opposite to the first direction DR1.

The scan lines GIL1 to GILn, GCL1 to GCLn, and GWL1 to GWLn+1 and the emission control lines EML1 to EMLn are arranged spaced from one another in the second direction DR2. The data lines DL1 to DLm extend from the data driving circuit 200 in a direction opposite to the second direction DR2, and are arranged spaced from one another in the first direction DR1.

In the example shown in FIG. 5, the scan driving circuit SDC and the emission driving circuit EDC are arranged to face each other with the pixels PX interposed therebetween, but the present disclosure is not limited thereto. For example, the scan driving circuit SDC and the emission driving circuit EDC may be disposed adjacent to each other in the non-display area NDA of the display panel DP. In an embodiment, the scan driving circuit SDC and the emission driving circuit EDC may be implemented with one circuit.

The plurality of pixels PX are electrically connected to the scan lines GIL1 to GILn, GCL1 to GCLn, and GWL1 to GWLn+1, the emission control lines EML1 to EMLn, and the data lines DL1 to DLm. Each of the plurality of pixels PX may be electrically connected to four scan lines and one emission control line. For example, as shown in FIG. 4, a first row of pixels may be connected to the scan lines GIL1, GCL1, GWL1, and GWL2 and the emission control line EML1. The i-th row of pixels may be connected to the scan lines GILi, GCLi, GWLi, and GWLi+1 and the emission control line EMLi. The n-th row of pixels may be connected to the scan lines GILn, GCLn, GWLn, and GWLn+1 and the emission control line EMLn.

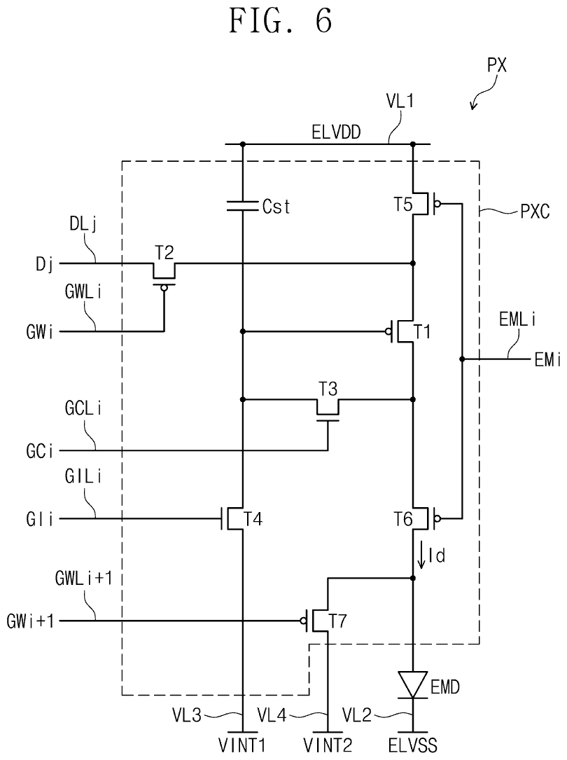

Each of the plurality of pixels PX includes a light emitting element EMD (see FIG. 6) and a pixel circuit PXC (see FIG. 6) for controlling the emission of the light emitting element EMD. The pixel circuit PXC may include one or more transistors and one or more capacitors. The scan driving circuit SDC and the emission driving circuit EDC may include transistors formed through the same process as the pixel circuit PXC.

Each of the plurality of pixels PX receives the first driving voltage ELVDD, the second driving voltage ELVSS, the first initialization voltage VINT1, and the second initialization voltage VINT2 from the voltage generator 300.

The scan driving circuit SDC receives the scan control signal SCS from the driving controller 100. The scan driving circuit SDC may output scan signals to the scan lines GIL1 to GILn, GCL1 to GCLn, and GWL1 to GWLn+1 in response to the scan control signal SCS.

The driving controller 100 according to an embodiment may determine an operating mode based on information included in the transmission signal TS. In an embodiment, the driving controller 100 may determine the operating mode as one of a single frequency mode SM and a multi-frequency mode MFM based on information included in the transmission signal TS.

When an image displayed on the display panel DP needs to be refreshed in the multi-frequency mode MFM, the driving controller 100 transmits the refresh request signal ARP_TE of an active level to the processor AP.

When the refresh request signal ARP_TE is at the active level, the processor AP transmits the transmission signal TS to the driving controller 100.

The detailed operations of the processor AP and the driving circuit DDI will be described in detail later.

FIG. 6 is a circuit diagram of a pixel PX, according to an embodiment of the present disclosure.

FIG. 6 illustrates an equivalent circuit diagram of the pixel PX connected to the j-th data line DLj among the data lines DL1 to DLm, the i-th scan lines GILi, GCLi, and GWLi and the (i+1)-th scan line GWLi+1 among the scan lines GIL1 to GILn, GCL1 to GCLn, and GWL1 to GWLn+1, and the i-th emission control line EMLi among the emission control lines EML1 to EMLn, which are illustrated in FIG. 5.

Each of the plurality of pixels PX shown in FIG. 5 may have the same circuit configuration as the pixel PX shown in FIG. 6.

Referring to FIG. 6, the pixel PX according to an embodiment includes the pixel circuit PXC and the at least one light emitting element EMD. In an embodiment, the light emitting element EMD may be a light emitting diode. In an embodiment, it is described that the one pixel PX includes the one light emitting element EMD. The pixel circuit PXC includes first to seventh transistors T1, T2, T3, T4, T5, T6, and T7 and a capacitor Cst.

In an embodiment, the third and fourth transistors T3 and T4 among the first to seventh transistors T1 to T7 are N-type transistors by using an oxide semiconductor as a semiconductor layer. Each of the first, second, fifth, sixth, and seventh transistors T1, T2, T5, T6, and T7 is a P-type transistor having a low-temperature polycrystalline silicon (LTPS) semiconductor layer. However, the present disclosure is not limited thereto. For example, all of the first to seventh transistors T1 to T7 may be P-type transistors or N-type transistors. In an embodiment, at least one of the first to seventh transistors T1 to T7 may be an N-type transistor, and the other(s) thereof may be P-type transistors. Moreover, the circuit configuration of a pixel according to an embodiment of the present disclosure is not limited to an embodiment of FIG. 6. A configuration of the pixel circuit PXC illustrated in FIG. 6 may be modified and implemented.

The scan lines GILi, GCLi, GWLi, and GWLi+1 may deliver scan signals Gli, GCi, GWi, and GWi+1, respectively. The emission control line EMLi may deliver an emission control signal EMi. The data line DLj delivers a data signal Dj. The data signal Dj may have a voltage level corresponding to the image signal RGB input to the electronic device ED (see FIG. 5). First to fourth driving voltage lines VL1, VL2, VL3, and VL4 may transfer the first driving voltage ELVDD, the second driving voltage ELVSS, the first initialization voltage VINT1, and the second initialization voltage VINT2, respectively.

The first transistor T1 includes a first electrode connected to the first driving voltage line VL1 via the fifth transistor T5, a second electrode electrically connected to an anode of the light emitting element EMD via the sixth transistor T6, and a gate electrode connected to one end of the capacitor Cst. The first transistor T1 may receive the data signal Dj delivered through the data line DLj depending on the switching operation of the second transistor T2 and then may supply a driving current Id to the light emitting element EMD.

The second transistor T2 includes a first electrode connected to the data line DLj, a second electrode connected to the first electrode of the first transistor T1, and a gate electrode connected to the scan line GWLi. The second transistor T2 may be turned on in response to the scan signal GWi transferred through the scan line GWLi and may transfer the data signal Dj transferred through the data line DLj to the first electrode of the first transistor T1.

The third transistor T3 includes a first electrode connected with the gate electrode of the first transistor T1, a second electrode connected with the second electrode of the first transistor T1, and a gate electrode connected with the scan line GCLi. The third transistor T3 may be turned on in response to the scan signal GCi transferred through the scan line GCLi, and thus, the gate electrode and the second electrode of the first transistor T1 may be connected, that is, the first transistor T1 may be diode-connected.

The fourth transistor T4 includes a first electrode connected with the gate electrode of the first transistor T1, a second electrode connected with the third driving voltage line VL3 through which the first initialization voltage VINT1 is transferred, and a gate electrode connected with the scan line GILi. The fourth transistor T4 may be turned on in response to the scan signal Gli transferred through the scan line GILi such that the first initialization voltage VINT1 is transferred to the gate electrode of the first transistor T1. Accordingly, an initialization operation of initializing a voltage of the gate electrode of the first transistor T1 may be performed.

The fifth transistor T5 includes a first electrode connected to the first driving voltage line VL1, a second electrode connected to the first electrode of the first transistor T1, and a gate electrode connected to the emission control line EMLi.

The sixth transistor T6 includes a first electrode connected to the second electrode of the first transistor T1, a second electrode connected with the anode of the light emitting element EMD, and a gate electrode connected with the emission control line EMLi.

The fifth transistor T5 and the sixth transistor T6 may be simultaneously turned on in response to the emission control signal EMi transferred through the emission control line EMLi. In this way, the first driving voltage ELVDD may be compensated for through the diode-connected transistor T1 so as to be supplied to the light emitting element EMD.

The seventh transistor T7 includes a first electrode connected to the second electrode of the sixth transistor T6, a second electrode connected to the fourth driving voltage line VL4, and a gate electrode connected to the scan line GWLi+1. The seventh transistor T7 is turned on in response to the scan signal GWi+1 transferred through the scan line GWLi+1 and bypasses a current of the anode of the light emitting element EMD to the fourth driving voltage line VLA.

As described above, one end of the capacitor Cst is connected to the gate electrode of the first transistor T1, and the other end of the capacitor Cst is connected to the first driving voltage line VL1. The cathode of the light emitting element EMD may be connected to the second driving voltage line VL2, to which the second driving voltage ELVSS is delivered. The structure of the pixel PX according to an embodiment is not limited to the structure illustrated in FIG. 6. For example, the number of transistors included in the one pixel PX, the number of capacitors included in the pixel PX, and the connection relationship between the transistors and the capacitors may be variously modified.

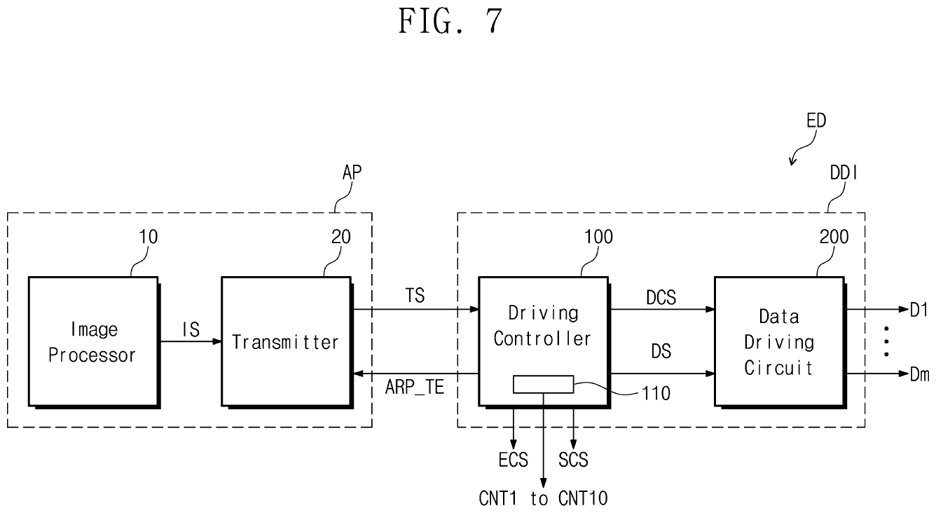

FIG. 7 is a block diagram showing a configuration of the processor AP and the driving circuit DDI of the electronic device ED.

Referring to FIG. 7, the processor AP includes an image processor 10 and a transmitter 20. The image processor 10 determines an operating mode of the electronic device ED (see FIG. 5) and generates an image control signal IS corresponding to the operating mode. The transmitter 20 converts the image control signal IS into the transmission signal TS and outputs the transmission signal TS.

In an embodiment, the processor AP transmits the transmission signal TS to the driving controller 100. The transmission signal TS may be a signal of a type suitable for an interface between the processor AP and the driving controller 100. In an embodiment, the interface between the processor AP and the driving controller 100 may be a Mobile Industry Processor Interface (“MIPI”).

The driving controller 100 receives the transmission signal TS provided from the processor AP. The driving controller 100 outputs the image data signal DS, the scan control signal SCS, the data control signal DCS, and the emission control signal ECS based on the transmission signal TS.

The data driving circuit 200 outputs the data signals D1 to Dm in response to the image data signal DS and the data control signal DCS. The data signals D1 to Dm may be provided to the pixels PX through the data lines DL1 to DLm as shown in FIG. 5.

The driving controller 100 may output the image data signal DS corresponding to the transmission signal TS only when the transmission signal TS is received from the processor AP. When an image displayed on the display panel DP needs to be refreshed in a multi-frequency mode MFM, the driving controller 100 transmits the refresh request signal ARP_TE of an active level to the processor AP.

For example, when the image data signal DS corresponding to at least part of the display panel DP (see FIG. 5) is not updated for a preset time in the multi-frequency mode MFM, the driving controller 100 may transmit the refresh request signal ARP_TE of an active level to the processor AP.

The driving controller 100 includes a counter circuit 110. In the multi-frequency mode MFM, the counter circuit 110 may output a plurality of count signals corresponding to a plurality of display areas of the display panel DP, respectively (see FIG. 5). When a count value of at least one of the plurality of count signals reaches a preset value, the driving controller 100 may transmit the refresh request signal ARP_TE to the processor AP.

In an embodiment, the counter circuit 110 may include a plurality of counters. In the multi-frequency mode MFM, each of the plurality of counters may correspond to a plurality of display areas of the display panel DP (see FIG. 5).

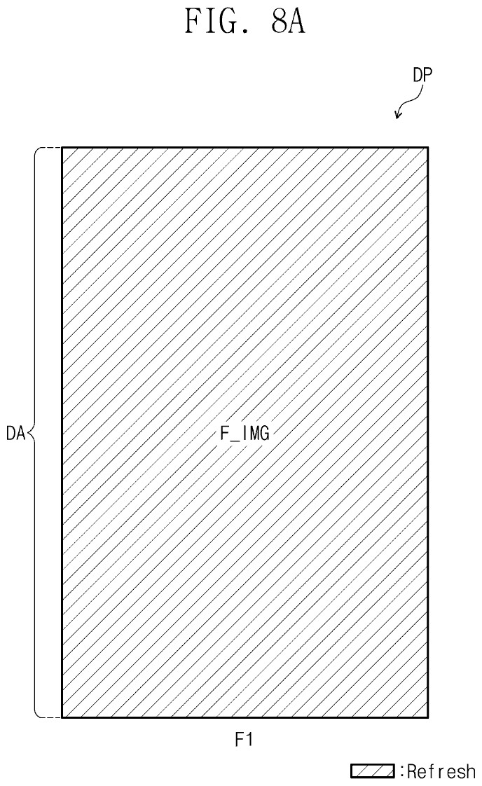

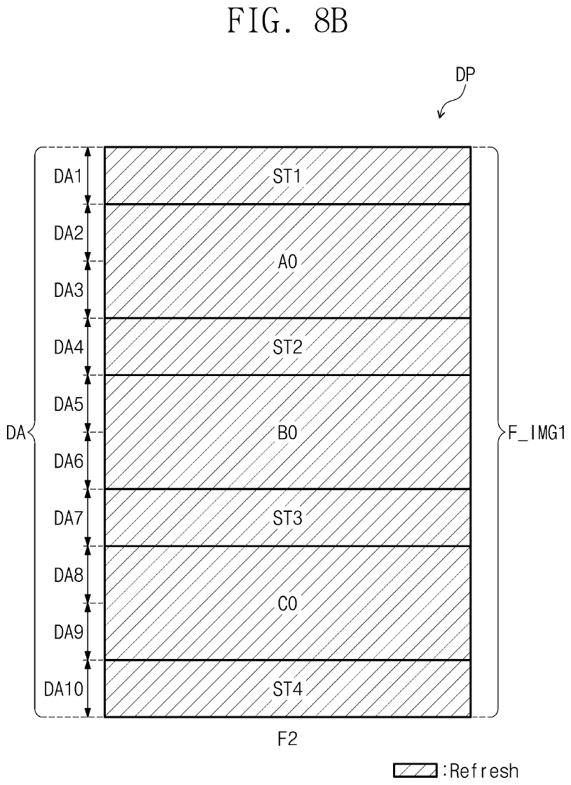

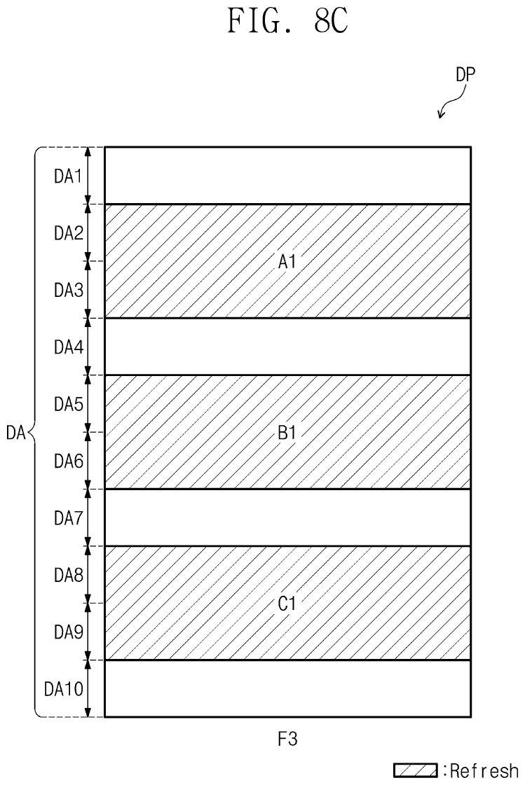

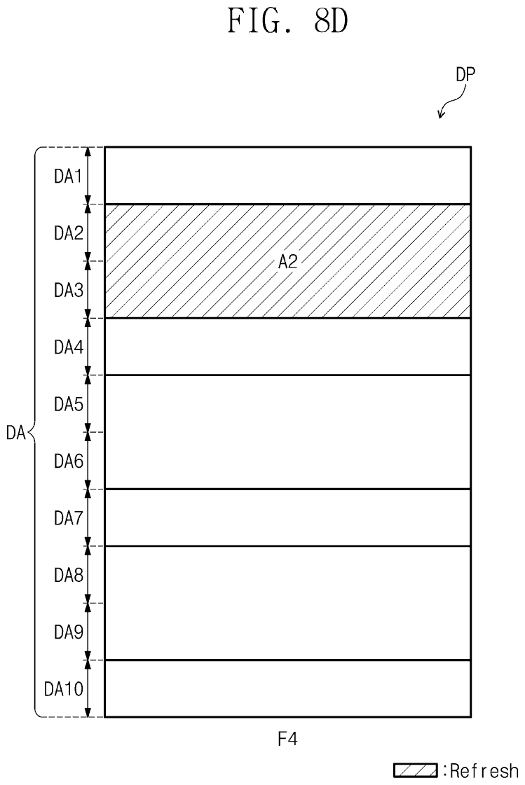

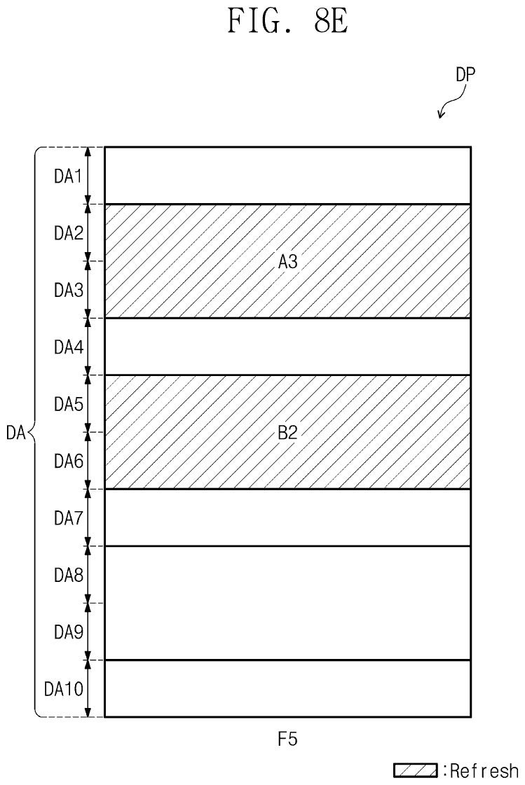

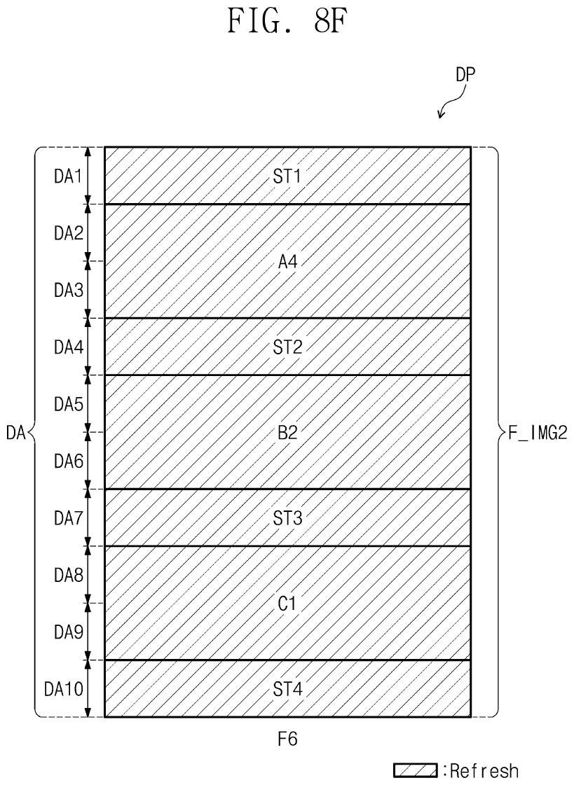

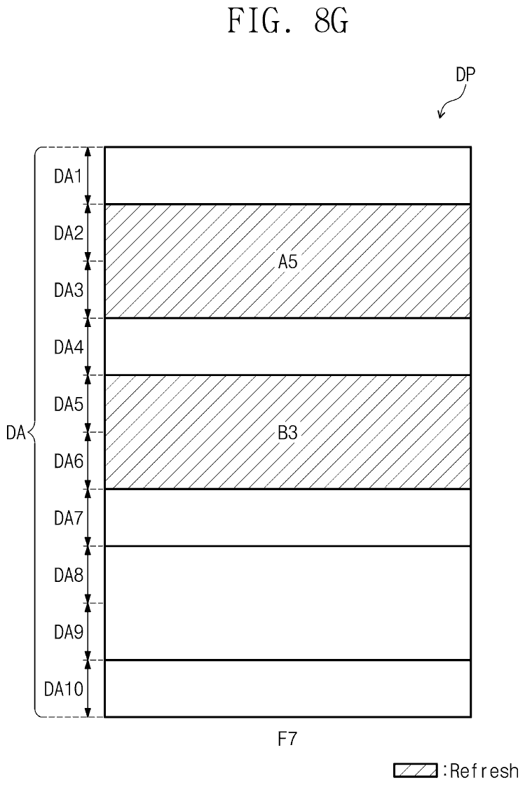

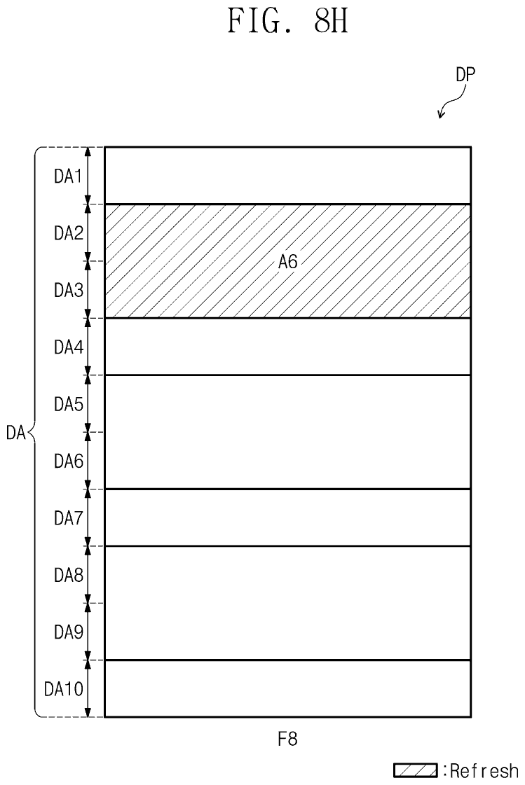

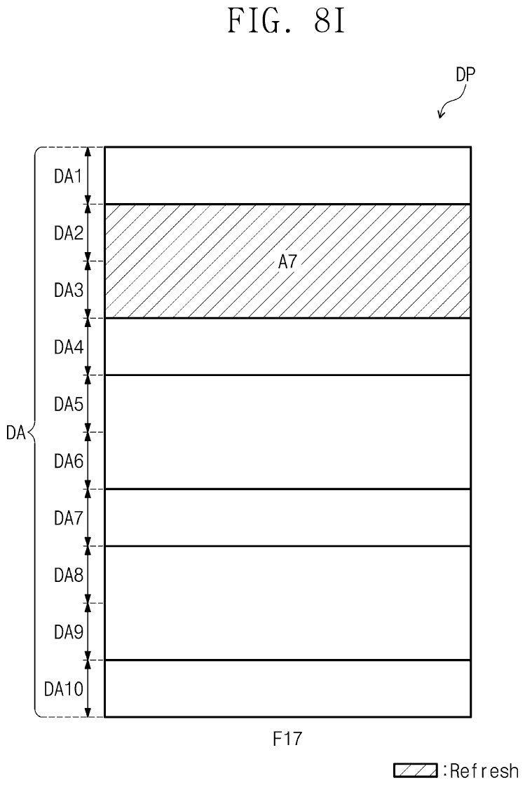

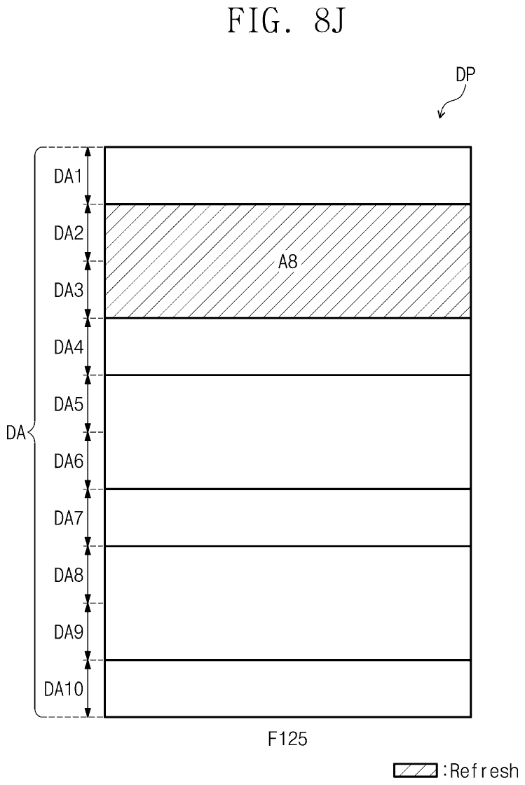

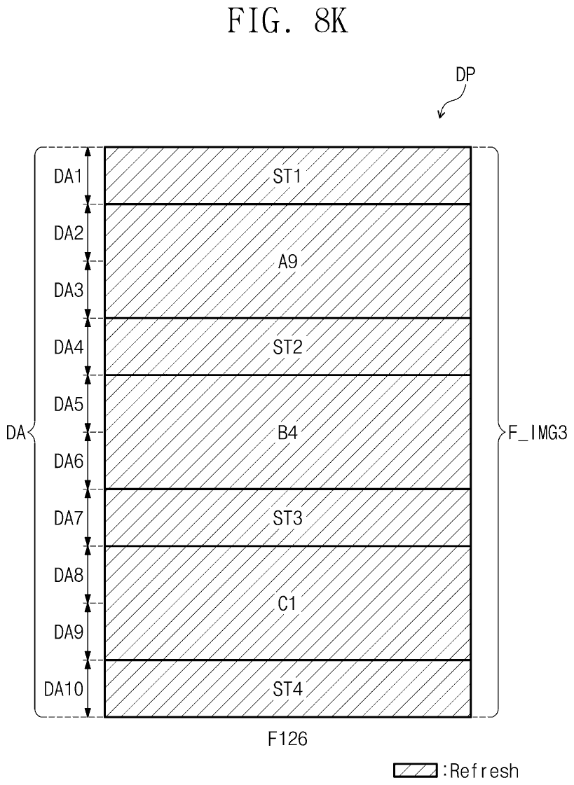

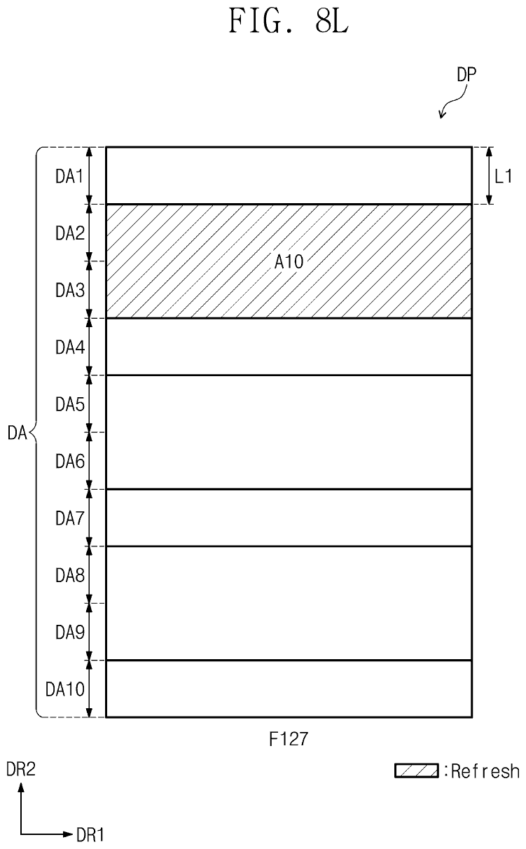

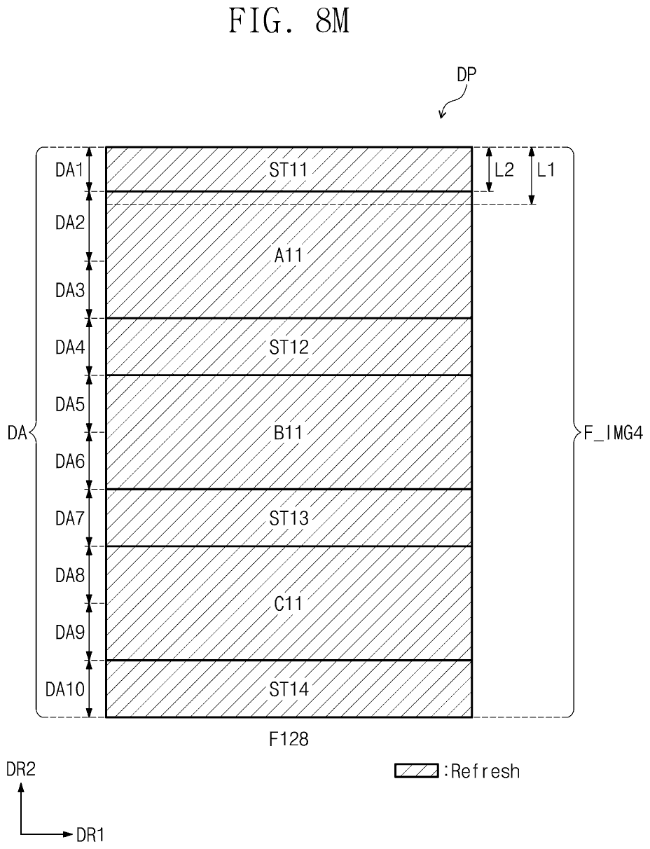

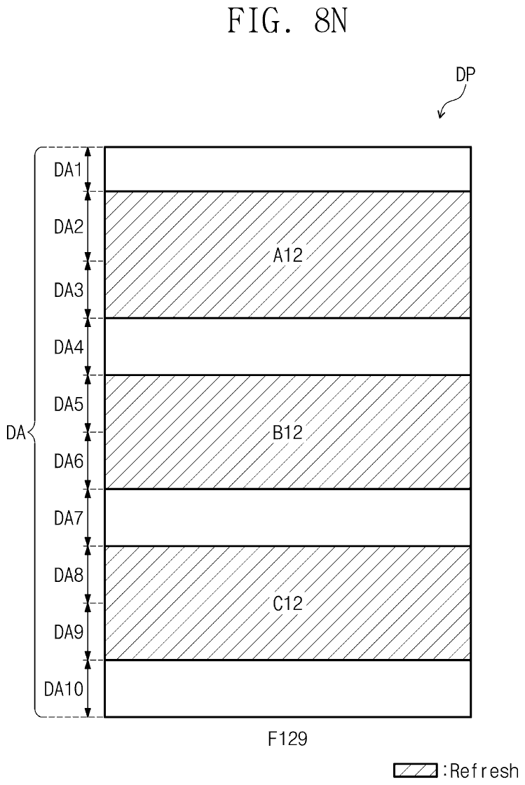

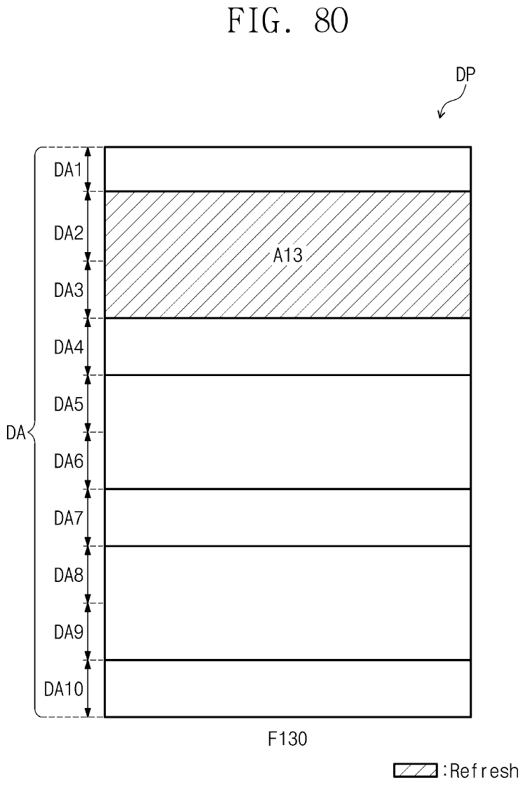

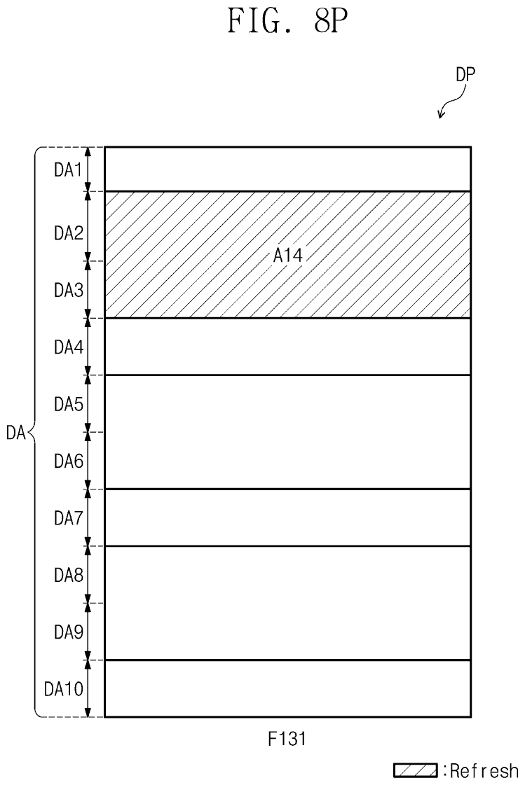

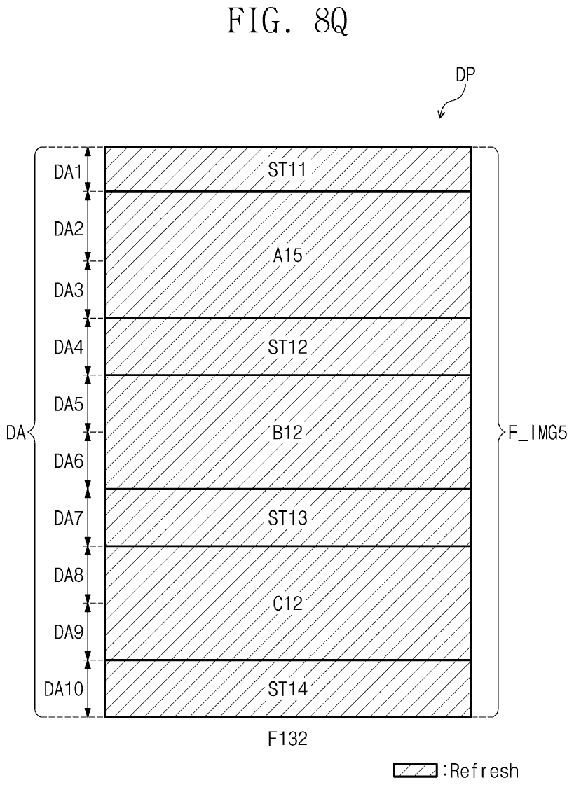

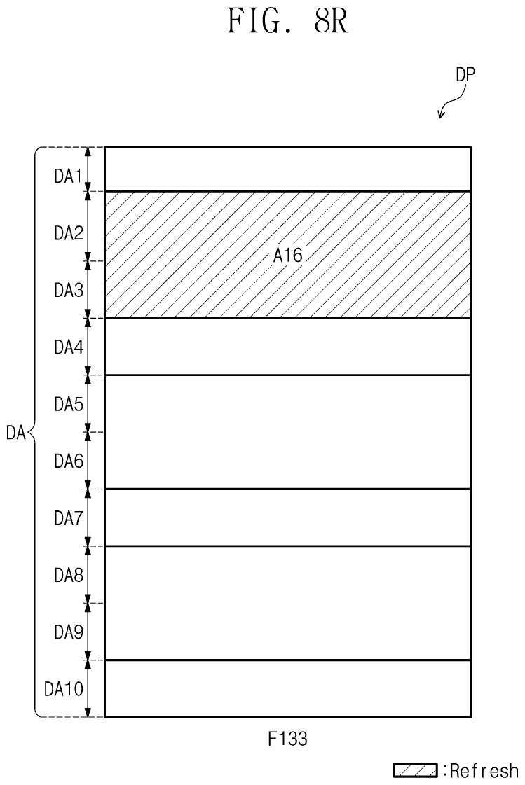

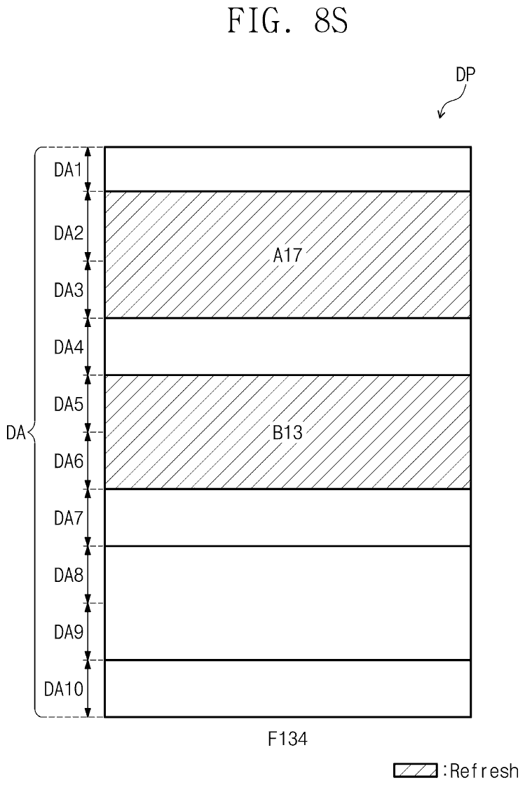

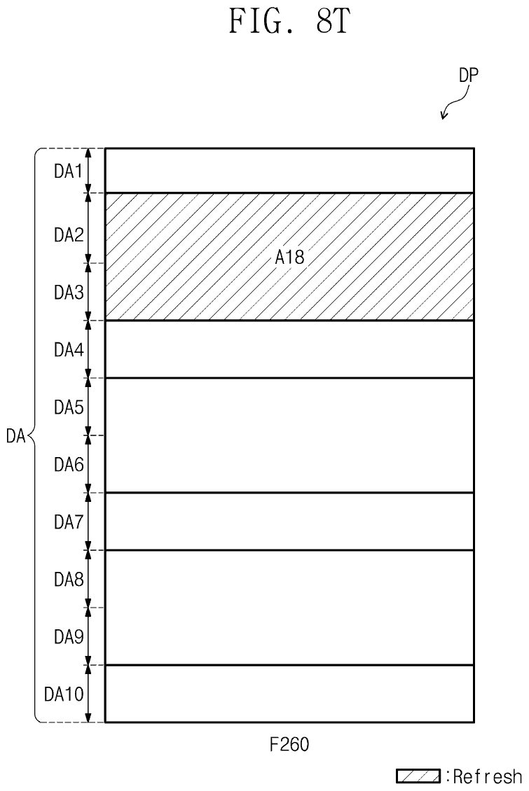

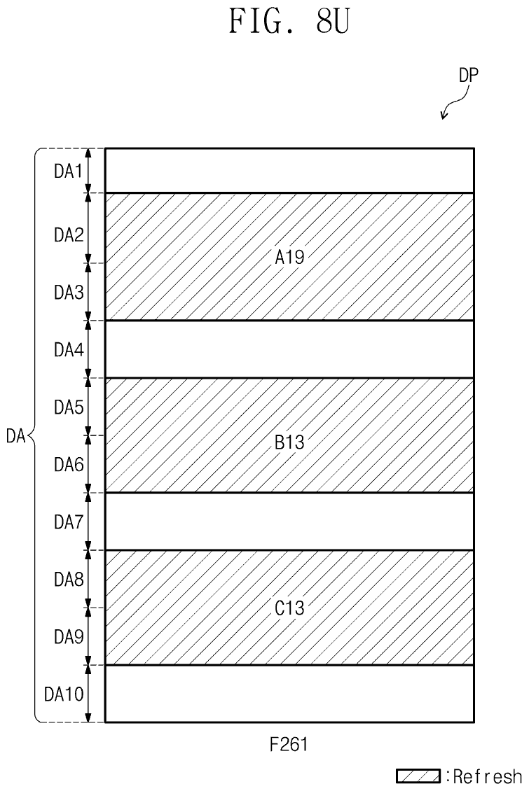

FIGS. 8A to 8U are drawings showing images displayed on the display panel DP.

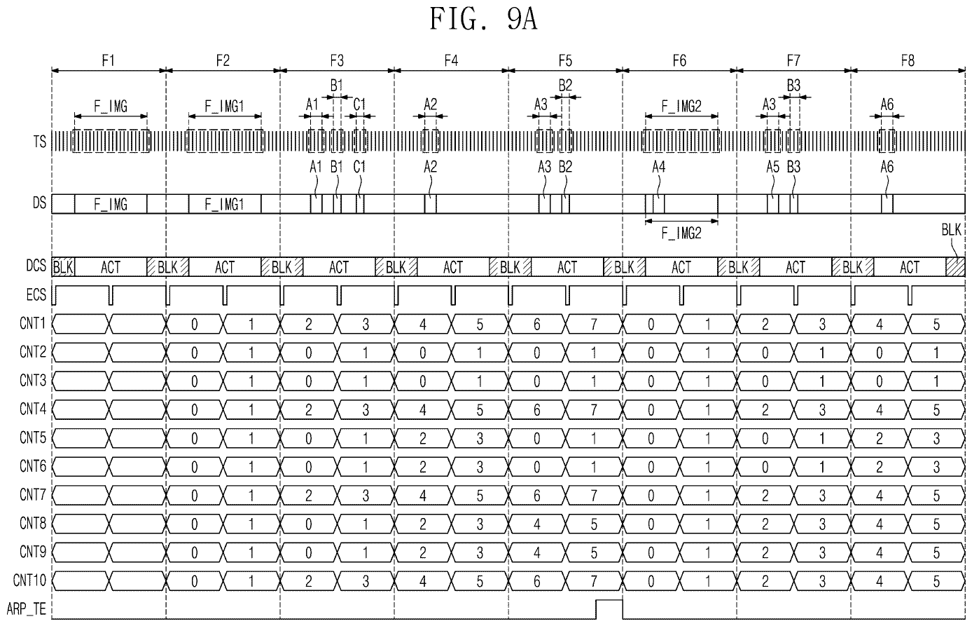

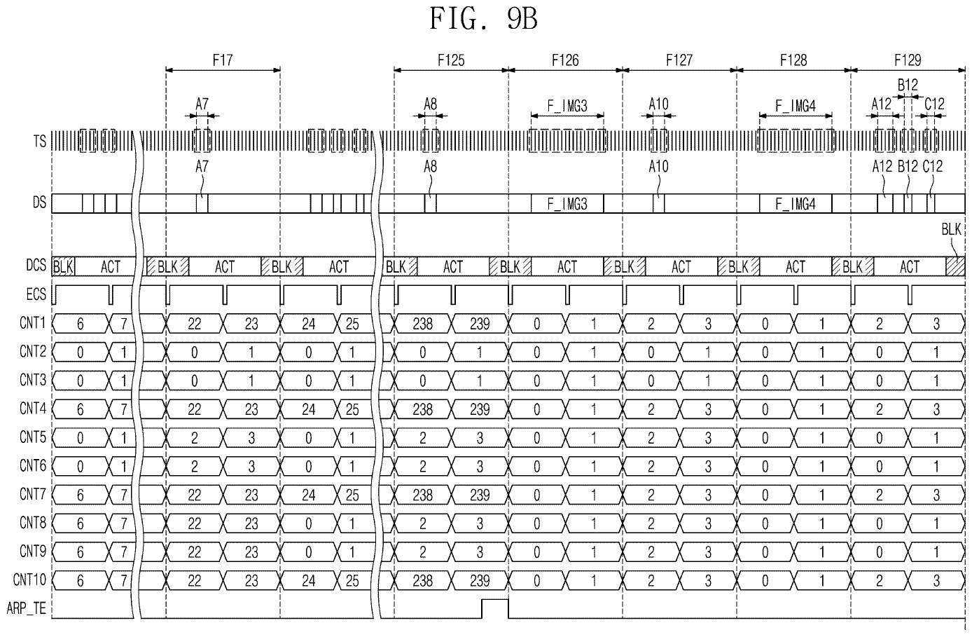

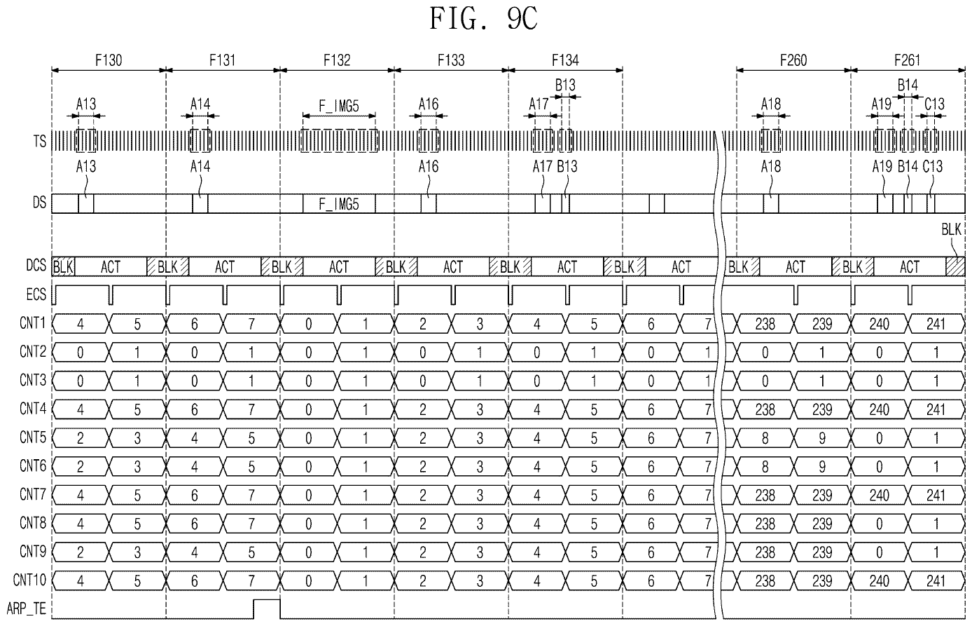

FIGS. 9A, 9B, and 9C are drawings for describing an operation of a processor and a driving circuit in a single frequency mode and a multi-frequency mode.

Referring to FIGS. 7, 8A and 9A, the processor AP and the driving circuit DDI operate in the single frequency mode during a first frame F1.

In the single frequency mode, a full image F_IMG is displayed in the display area DA of the display panel DP. In the single frequency mode, the processor AP transmits the transmission signal TS corresponding to the full image F_IMG to the driving circuit DDI. The hatched portions in FIGS. 8A to 8V indicate portions (i.e., a portion of the display panel DP that is refreshed) where the data signals D1 to Dm are provided from the driving circuit DDI to the display panel DP (see FIG. 5).

The driving controller 100 in the driving circuit DDI outputs the image data signal DS and the data control signal DCS based on the transmission signal TS. The data control signal DCS includes a blank period BLK and an active period ACT. During the active period ACT of the data control signal DCS, the driving controller 100 outputs the image data signal DS to the data driving circuit 200.

In the single frequency mode, the counter circuit 110 in the driving controller 100 does not operate. That is, in the single frequency mode, the driving controller 100 does not reference count signals CNT1 to CNT10 output from the counter circuit 110.

The driving controller 100 outputs the emission control signal ECS to the emission driving circuit EDC. The emission control signal ECS may be a signal that transitions to an active level (e.g., a low level) twice during one frame.

The counter circuit 110 in the driving controller 100 may output the first to tenth count signals CNT1 to CNT10 in synchronization with the emission control signal ECS. In an embodiment, the counter circuit 110 is described as operating in synchronization with the emission control signal ECS, but the present disclosure is not limited thereto. The counter circuit 110 may operate in response to a signal indicating the start of a frame.

The counter circuit 110 counts up when the emission control signal ECS transitions from a high level to a low level and outputs the first to tenth count signals CNT1 to CNT10. The first to tenth count signals CNT1 to CNT10 correspond to first to tenth display areas DA1 to DA10, respectively.

When the image data signal DS corresponding to the first to tenth display areas DA1 to DA10 is output, the counter circuit 110 may reset the first to tenth count signals CNT1 to CNT10 to 0. In other words, the first to tenth count signals CNT1 to CNT10 indicate the time during which the same image is maintained on the first to tenth display areas DA1 to DA10 of the display panel DP.

The processor AP and the driving circuit DDI operate in the multi-frequency mode MFM from a second frame F2 to a 261st frame F261.

Referring to FIGS. 8B and 9A, in the multi-frequency mode MFM, the processor AP may divide the display panel DP into a plurality of display areas. In the example shown in FIG. 8B, the display area DA of the display panel DP is divided into the first to tenth display areas DA1 to DA10. However, the present disclosure is not limited thereto.

A full image F_IMG1 is displayed in the display area DA of the display panel DP. The full image F_IMG1 includes still images ST1, ST2, ST3, and ST4 and videos A0, B0, and C0. For example, it is assumed that the first, fourth, seventh, and tenth display areas DA1, DA4, DA7, and DA10 display the still images ST1, ST2, ST3, and ST4, respectively, and the second, third, fifth, sixth, eighth, and ninth display areas DA2, DA3, DA5, DA6, DA8, and DA9 display videos A0, B0, and C0. In the example shown in FIG. 8B, the second and third display areas DA2 and DA3 display the video A0; the fifth and sixth display areas DA5 and DA6 display the video B0; and the eighth and ninth display areas DA8 and DA9 display the video C0.

In the multi-frequency mode MFM, the transmission signal TS output from the processor AP may include information about each of the first to tenth display areas DA1 to DA10. The processor AP may provide the driving circuit DDI with a start location and frequency information of each of the first to tenth display areas DA1 to DA10.

In the second frame F2, which is the first frame of the multi-frequency mode MFM, the processor AP transmits the transmission signal TS corresponding to the full image F_IMG1 to the driving circuit DDI. During the active period ACT of the data control signal DCS, the driving controller 100 in the driving circuit DDI outputs the image data signal DS corresponding to the full image F_IMG1 to the data driving circuit 200.

In an embodiment, it is assumed that an operating frequency of each of the first, fourth, seventh, and tenth display areas DA1, DA4, DA7, and DA10 is 30 Hz; an operating frequency of each of the second and third display areas DA2 and DA3 is 120 Hz; an operating frequency of each of the fifth and sixth display areas DA5 and DA6 is 60 Hz; and an operating frequency of each of the eighth and ninth display areas DA8 and DA9 is 40 Hz.

The counter circuit 110 counts up in response to the emission control signal ECS and outputs the first to tenth count signals CNT1 to CNT10. In the second frame F2, all of the first to tenth count signals CNT1 to CNT10 are ‘1’.

Referring to FIGS. 8C and 9A, from the second frame (i.e., a third frame F3) of the multi-frequency mode MFM, the processor AP transmits the transmission signal TS corresponding to the updated video among images displayed on the display panel DP to the driving circuit DDI. In the example shown in FIG. 8C, the processor AP transmits the transmission signal TS corresponding to videos A1, B1, and C1 to the driving circuit DDI. During the active period ACT in the third frame F3, the processor AP does not transmit the still images ST1, ST2, ST3, and ST4 corresponding to the first, fourth, seventh, and tenth display areas DA1, DA4, DA7, and DA10 to the driving circuit DDI again.

During the active period ACT of the data control signal DCS, the driving controller 100 in the driving circuit DDI outputs the image data signal DS corresponding to the videos A1, B1, and C1 to the data driving circuit 200.

The counter circuit 110 counts up in response to the emission control signal ECS and outputs the first to tenth count signals CNT1 to CNT10. In the third frame F3, the second, third, fifth, sixth, eighth, and ninth count signals CNT2, CNT3, CNT5, CNT6, CNT8, and CNT9 corresponding to the second, third, fifth, sixth, eighth, and ninth display areas DA2, DA3, DA5, DA6, DA8, and DA9, respectively, are reset to ‘0’ and then counted up to ‘1’. The first, fourth, seventh, and tenth count signals CNT1, CNT4, CNT7, and CNT10 corresponding to the first, fourth, seventh, and tenth display areas DA1, DA4, DA7, and DA10 corresponding to the still image, respectively, are counted up to ‘3’.

Referring to FIGS. 8D and 9A, in a fourth frame F4 which is the third frame of the multi-frequency mode MFM, the processor AP transmits the transmission signal TS corresponding to the updated video among images displayed on the display panel DP to the driving circuit DDI. In the example shown in FIG. 8D, the processor AP transmits the transmission signal TS corresponding to a video A2 to the driving circuit DDI.

During the active period ACT of the data control signal DCS, the driving controller 100 in the driving circuit DDI outputs the image data signal DS corresponding to the video A2 to the data driving circuit 200. In the fourth frame F4, the second and third count signals CNT2 and CNT3 corresponding to the second and third display areas DA2 and DA3, respectively, are reset to ‘0’ and then counted up to ‘1’. The fifth, sixth, eighth, and ninth count signals CNT5, CNT6, CNT8, and CNT9 corresponding to the fifth, sixth, eighth, and ninth display areas DA5, DA6, DA8, and DA9 corresponding to the still image, respectively, are counted up to ‘3’. The first, fourth, seventh, and tenth count signals CNT1, CNT4, CNT7, and CNT10 corresponding to the first, fourth, seventh, and tenth display areas DA1, DA4, DA7, and DA10 corresponding to the still image, respectively, are counted up to ‘5’.

Referring to FIGS. 8E and 9A, in a fifth frame F5 which is the fourth frame of the multi-frequency mode MFM, the processor AP transmits the transmission signal TS corresponding to the updated video among images displayed on the display panel DP to the driving circuit DDI. In the example shown in FIG. 8E, the processor AP transmits the transmission signal TS corresponding to videos A3 and B2 to the driving circuit DDI.

During the active period ACT of the data control signal DCS, the driving controller 100 in the driving circuit DDI outputs the image data signal DS corresponding to the videos A3 and B2 to the data driving circuit 200.

Because the operating frequency of the eighth and ninth display areas DA8 and DA9 is 40 Hz, the driving controller 100 transmits the refresh request signal ARP_TE of an active level (e.g., a high level) to the processor AP when the eighth and ninth count signals CNT8 and CNT9 corresponding to the eighth and ninth display areas DA8 and DA9 reach a preset value (e.g., 5).

Referring to FIGS. 8F and 9A, when the refresh request signal ARP_TE is at an active level, the processor AP transmits the transmission signal TS corresponding to a full image F_IMG2 to the driving circuit DDI in the next frame (i.e., a sixth frame F6).

The full image F_IMG2 includes still images ST1, ST2, ST3, and ST4 and videos A4, B2, and C1. Except for a video A4 of the second and third display areas DA2 and DA3, images of the first and fourth to tenth display areas DA1 and DA4 to DA10 are not updated, and thus the images may be the same as images of the previous frame. In other words, the still images ST1, ST2, ST3, and ST4 of the sixth frame F6 are the same as the still images ST1, ST2, ST3, and ST4 of the second frame F2 shown in FIG. 8B. The video B2 is the same as the video B2 shown in FIG. 8E. The video C1 is the same as the video C1 shown in FIG. 8B.

In the sixth frame F6, the first to tenth display areas DA1 to DA10 of the display panel DP are refreshed by the image data signal DS, and thus all of the first to tenth count signals CNT1 to CNT10 may be reset to ‘0’ and then may be counted up to 1.

Referring to FIGS. 8G and 9A, in a seventh frame F7, the processor AP transmits the transmission signal TS corresponding to the updated video among images displayed on the display panel DP to the driving circuit DDI. In the example shown in FIG. 8G, the processor AP transmits the transmission signal TS corresponding to videos A5 and B3 to the driving circuit DDI.

During the active period ACT of the data control signal DCS, the driving controller 100 in the driving circuit DDI outputs the image data signal DS corresponding to the videos A5 and B3 to the data driving circuit 200.

Referring to FIGS. 8H and 9A, in an eighth frame F8, the processor AP transmits the transmission signal TS corresponding to the updated video among images displayed on the display panel DP to the driving circuit DDI. In the example shown in FIG. 8H, the processor AP transmits the transmission signal TS corresponding to a video A6 to the driving circuit DDI.

During the active period ACT of the data control signal DCS, the driving controller 100 in the driving circuit DDI outputs the image data signal DS corresponding to the video A6 to the data driving circuit 200.

Referring to FIGS. 8I and 9B, in a seventeenth frame F17, the processor AP transmits the transmission signal TS corresponding to the updated video among images displayed on the display panel DP to the driving circuit DDI. In the example shown in FIG. 8I, the processor AP transmits the transmission signal TS corresponding to a video A7 to the driving circuit DDI.

During the active period ACT of the data control signal DCS, the driving controller 100 in the driving circuit DDI outputs the image data signal DS corresponding to the video A7 to the data driving circuit 200.

Referring to FIGS. 8J and 9B, in a 125th frame F125, the processor AP transmits the transmission signal TS corresponding to the updated video among images displayed on the display panel DP to the driving circuit DDI. In the example shown in FIG. 8J, the processor AP transmits the transmission signal TS corresponding to a video A8 to the driving circuit DDI.

During the active period ACT of the data control signal DCS, the driving controller 100 in the driving circuit DDI outputs the image data signal DS corresponding to the video A8 to the data driving circuit 200.

When the first, fourth, seventh, and tenth count signals CNT1, CNT4, CNT7, and CNT10 corresponding to the first, fourth, seventh, and tenth display areas DA1, DA4, DA7, and DA10, respectively, reach a preset value (e.g., 239) when the operating frequency of the first, fourth, seventh, and tenth display areas DA1, DA4, DA7, and DA10 is 1 Hz, the driving controller 100 transmits the refresh request signal ARP_TE of an active level (e.g., a high level) to the processor AP.

Referring to FIGS. 8K and 9B, when the refresh request signal ARP_TE is at an active level, the processor AP transmits the transmission signal TS corresponding to a full image F_IMG3 to the driving circuit DDI in a 126th frame F126.

The full image F_IMG3 includes still images ST1, ST2, ST3, and ST4 and videos A9, B4, and C1. In the 126th frame F126, the first to tenth display areas DA1 to DA10 of the display panel DP are refreshed by the image data signal DS, and thus all of the first to tenth count signals CNT1 to CNT10 may be reset to ‘0’ and then may be counted up to 1.

Referring to FIGS. 8L and 9B, in a 127th frame F127, the processor AP transmits the transmission signal TS corresponding to the updated video among images displayed on the display panel DP to the driving circuit DDI. In the example shown in FIG. 8L, the processor AP transmits the transmission signal TS corresponding to a video A10 to the driving circuit DDI.

During the active period ACT of the data control signal DCS, the driving controller 100 in the driving circuit DDI outputs the image data signal DS corresponding to the video A10 to the data driving circuit 200.

Referring to FIGS. 8M and 9B, when a start location (or size) of at least one of the first to tenth display areas DA1 to DA10 is changed, or the operating frequency of at least one of the first to tenth display areas DA1 to DA10 is changed, the processor AP transmits a full image F_IMG4 of the display area DA to the driving circuit DDI.

A length L2 of the first display area DA1 in the second direction DR2 illustrated in FIG. 8M is different from a length L1 of the first display area DA1 in the second direction DR2 illustrated in FIG. 8L.

Moreover, it is assumed that an operating frequency of each of the first, fourth, seventh, and tenth display areas DA1, DA4, DA7, and DA10 is 30 Hz; an operating frequency of each of the second and third display areas DA2 and DA3 is 120 Hz; an operating frequency of each of the fifth and sixth display areas DA5 and DA6 is 24 Hz; and an operating frequency of each of the eighth and ninth display areas DA8 and DA9 is 1 Hz.

The full image F_IMAG4 includes still images ST11, ST12, ST13, and ST14 and videos A11, B11, and C11. For example, it is assumed that the first, fourth, seventh, and tenth display areas DA1, DA4, DA7, and DA10 display the still images ST11, ST12, ST13, and ST14, respectively, and the second, third, fifth, sixth, eighth, and ninth display areas DA2, DA3, DA5, DA6, DA8, and DA9 display videos A11, B11, and C11. In the example shown in FIG. 8M, the second and third display areas DA2 and DA3 display the video A11; the fifth and sixth display areas DA5 and DA6 display the video B11; and the eighth and ninth display areas DA8 and DA9 display the video C11.

Referring to FIGS. 8N and 9B, in a 129th frame F129, the processor AP transmits the transmission signal TS corresponding to the updated video among images displayed on the display panel DP to the driving circuit DDI. The processor AP transmits the transmission signal TS corresponding to videos A12, B12, and C12 to the driving circuit DDI.

During the active period ACT of the data control signal DCS, the driving controller 100 in the driving circuit DDI outputs the image data signal DS corresponding to the videos A12, B12, and C12 to the data driving circuit 200.

The counter circuit 110 counts up in response to the emission control signal ECS and outputs the first to tenth count signals CNT1 to CNT10. In the 129th frame F129, the second, third, fifth, sixth, eighth, and ninth count signals CNT2, CNT3, CNT5, CNT6, CNT8, and CNT9 corresponding to the second, third, fifth, sixth, eighth, and ninth display areas DA2, DA3, DA5, DA6, DA8, and DA9 are reset to ‘0’ and then counted up to ‘1’. The first, fourth, seventh, and tenth count signals CNT1, CNT4, CNT7, and CNT10 corresponding to the first, fourth, seventh, and tenth display areas DA1, DA4, DA7, and DA10 corresponding to the still image are counted up to ‘3’.

Referring to FIGS. 8O and 9C, in a 130th frame F130, the processor AP transmits the transmission signal TS corresponding to the updated video among images displayed on the display panel DP to the driving circuit DDI. The processor AP transmits the transmission signal TS corresponding to a video A13 to the driving circuit DDI.

During the active period ACT of the data control signal DCS, the driving controller 100 in the driving circuit DDI outputs the image data signal DS corresponding to the video A13 to the data driving circuit 200.

The counter circuit 110 counts up in response to the emission control signal ECS and outputs the first to tenth count signals CNT1 to CNT10. In the 130th frame F130, the second and third count signals CNT2 and CNT3 corresponding to the second and third display areas DA2 and DA3 are reset to ‘0’ and then counted up to ‘1’. The first and fourth to tenth count signals CNT1 and CNT4 to CNT10 corresponding to the first and fourth to tenth display areas DA1 and DA4 to DA10, which are not refreshed, are counted up.

Referring to FIGS. 8P and 9C, in a 131st frame F131, the processor AP transmits the transmission signal TS corresponding to the updated video among images displayed on the display panel DP to the driving circuit DDI. The processor AP transmits the transmission signal TS corresponding to a video A14 to the driving circuit DDI.

During the active period ACT of the data control signal DCS, the driving controller 100 in the driving circuit DDI outputs the image data signal DS corresponding to the video A14 to the data driving circuit 200.

The counter circuit 110 counts up in response to the emission control signal ECS and outputs the first to tenth count signals CNT1 to CNT10. In the 131st frame F131, the second and third count signals CNT2 and CNT3 corresponding to the second and third display areas DA2 and DA3 are reset to ‘0’ and then counted up to ‘1’. The first and fourth to tenth count signals CNT1 and CNT4 to CNT10 corresponding to the first and fourth to tenth display areas DA1 and DA4 to DA10, which are not refreshed, are counted up.

When each of the first, fourth, seventh, and tenth count signals CNT1, CNT4, CNT7, and CNT10 is ‘7’ if the operating frequency of each of the first, fourth, seventh, and tenth display areas DA1, DA4, DA7, and DA10, which display still images, is 30 Hz. the driving controller 100 transmits the refresh request signal ARP_TE of an active level to the processor AP.

Referring to FIGS. 8Q and 9C, when the refresh request signal ARP_TE is at an active level, the processor AP transmits the transmission signal TS corresponding to a full image F_IMG5 to the driving circuit DDI in the next frame (i.e., a 132nd frame F132).

The full image F_IMG5 includes still images ST11, ST12, ST13, and ST14 and videos A15, B12, and C12. Except for a video A14 of the second and third display areas DA2 and DA3, images of the first and fourth to tenth display areas DA1 and DA4 to DA10 are not updated, and thus the images may be the same as images of the previous frame. In other words, the still images ST11, ST12, ST13, and ST14 of the 132nd frame F132 are the same as the still images ST11, ST12, ST13, and ST14 of the 128th frame F128 shown in FIG. 8M, and the videos B12 and C12 of the 132nd frame F132 are the same as the videos B12 and C12 of the 129th frame F129 shown in FIG. 8N.

In the 132nd frame F132, the first to tenth display areas DA1 to DA10 of the display panel DP are refreshed by the image data signal DS, and thus all of the first to tenth count signals CNT1 to CNT10 may be reset to ‘0’ and then may be counted up to 1.

Referring to FIGS. 8R and 9C, in a 133rd frame F133, the processor AP transmits the transmission signal TS corresponding to the updated video among images displayed on the display panel DP to the driving circuit DDI. The processor AP transmits the transmission signal TS corresponding to a video A16 to the driving circuit DDI.

During the active period ACT of the data control signal DCS, the driving controller 100 in the driving circuit DDI outputs the image data signal DS corresponding to the video A16 to the data driving circuit 200.

The counter circuit 110 counts up in response to the emission control signal ECS and outputs the first to tenth count signals CNT1 to CNT10. In the 133rd frame F133, the second and third count signals CNT2 and CNT3 corresponding to the second and third display areas DA2 and DA3 are reset to ‘0’ and then counted up to ‘1’. The first and fourth to tenth count signals CNT1 and CNT4 to CNT10 corresponding to the first and fourth to tenth display areas DA1 and DA4 to DA10, which are not refreshed, are counted up.

Referring to FIGS. 8S and 9C, in a 134th frame F134, the processor AP transmits the transmission signal TS corresponding to the updated video among images displayed on the display panel DP to the driving circuit DDI. The processor AP transmits the transmission signal TS corresponding to videos A17 and B13 to the driving circuit DDI.

During the active period ACT of the data control signal DCS, the driving controller 100 in the driving circuit DDI outputs the image data signal DS corresponding to the videos A17 and B13 to the data driving circuit 200.

The counter circuit 110 counts up in response to the emission control signal ECS and outputs the first to tenth count signals CNT1 to CNT10. In the 134th frame F134, the second, third, fifth, and sixth count signals CNT2, CNT3, CNT5, and CNT6 corresponding to the second, third, fifth, and sixth display areas DA2, DA3, DA5, and DA6 are reset to ‘0’ and then counted up to ‘1’. The first, fourth, and seventh to tenth count signals CNT1, CNT4, and CNT7 to CNT10 corresponding to the first, fourth, and seventh to tenth display areas DA1, DA4, and DA7 to DA10, which are not refreshed, are counted up.

Referring to FIGS. 8T and 9C, in a 260th frame F260, the processor AP transmits the transmission signal TS corresponding to the updated video among images displayed on the display panel DP to the driving circuit DDI. The processor AP transmits the transmission signal TS corresponding to a video A18 to the driving circuit DDI.

During the active period ACT of the data control signal DCS, the driving controller 100 in the driving circuit DDI outputs the image data signal DS corresponding to the video A18 to the data driving circuit 200.

The counter circuit 110 counts up in response to the emission control signal ECS and outputs the first to tenth count signals CNT1 to CNT10. In the 260th frame F260, the second and third count signals CNT2 and CNT3 corresponding to the second and third display areas DA2 and DA3 are reset to ‘0’ and then counted up to ‘1’. The first and fourth to tenth count signals CNT1 and CNT4 to CNT10 corresponding to the first and fourth to tenth display areas DA1 and DA4 to DA10, which are not refreshed, are counted up.

Referring to FIGS. 8U and 9C, in a 261st frame F261, the processor AP transmits the transmission signal TS corresponding to the updated video among images displayed on the display panel DP to the driving circuit DDI. When the frequency of the second and third display areas DA2 and DA3 is 120 Hz, the operating frequency of the fifth and sixth display areas DA5 and DA6 is 24 Hz, and the operating frequency of the eighth and ninth display areas DA8 and DA9 is 1 Hz, the processor AP transmits the transmission signal TS corresponding to newly updated videos A19, B14, and C13 to the driving circuit DDI in the 261st frame F261.

During the active period ACT of the data control signal DCS, the driving controller 100 in the driving circuit DDI outputs the image data signal DS corresponding to the videos A17, B14, and C13 to the data driving circuit 200.

The counter circuit 110 counts up in response to the emission control signal ECS and outputs the first to tenth count signals CNT1 to CNT10. In the 261st frame F261, the second, third, fifth, sixth, eighth, and ninth count signals CNT2, CNT3, CNT5, CNT6, CNT8, and CNT9 corresponding to the second, third, fifth, sixth, eighth, and ninth display areas DA2, DA3, DA5, DA6, DA8, and DA9 are reset to ‘0’ and then counted up to ‘1’. The first, fourth, seventh, and tenth count signals CNT1, CNT4, CNT7, and CNT10 corresponding to the first, fourth, seventh, and tenth display areas DA1, DA4, DA7, and DA10, which are not refreshed, are counted up.

Although an embodiment of the present disclosure has been described for illustrative purposes, those skilled in the art will appreciate that various modifications, and substitutions are possible, without departing from the scope and spirit of the present disclosure as disclosed in the accompanying claims. Accordingly, the technical scope of the present disclosure is not limited to the detailed description of this specification, but should be defined by the claims.

A processor of an electronic device having such a configuration may transmit a transmission signal including information (e.g., a single frequency mode and a multi-frequency mode) and an image signal to a driving circuit. A driving circuit of the electronic device may operate in the single frequency mode and the multi-frequency mode depending on the information provided from the processor.

An electronic device may minimize power consumption by lowering the operating frequency of all or part of the display panel in the multi-frequency mode.

The driving circuit of the electronic device transmits a refresh request signal to the processor when it is determined that a refresh is necessary in the multi-frequency mode. The processor may prevent image degradation in some display areas operating at a low operating frequency by transmitting a transmission signal to the electronic device in response to the refresh request signal.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. An electronic device comprising:
a display panel;
a processor configured to output a transmission signal; and
a driving circuit configured to receive the transmission signal and to output a data signal such that an image is displayed on the display panel based on the transmission signal,
wherein, when a current image corresponding to a first part of the display panel is different from a previous image corresponding to the first part of the display panel and the processor does not receive a refresh request signal from the driving circuit, the processor outputs the transmission signal, which corresponds to the first part of the display panel and does not include a still image displayed on a second part of the display panel,
wherein, when a display time of the still image displayed on the second part of the display panel reaches a preset time, the driving circuit transmits the refresh request signal to the processor, and
wherein the processor outputs the transmission signal, which includes the still image in response to the refresh request signal.

2. The electronic device of claim 1, wherein when the transmission signal, which corresponds to the first part of the display panel is received, the driving circuit outputs the data signal, which corresponds to the first part of the display panel to the display panel.

3. The electronic device of claim 1, wherein the processor outputs the transmission signal, which corresponds to a full image to be displayed on an entire display area of the display panel in response to the refresh request signal.

4. The electronic device of claim 3, wherein the full image includes a video corresponding to the first part of the display panel and the still image corresponding to the second part of the display panel.

5. The electronic device of claim 1, wherein the processor and the driving circuit operate in a single frequency mode and a multi-frequency mode,
wherein, in the single frequency mode, an entirety of the display panel is driven at an identical frequency, and
wherein, in the multi-frequency mode, a first display area of the display panel is driven at a first operating frequency, and a second display area corresponding to the first part of the display panel is driven at a second operating frequency different from the first operating frequency.

6. The electronic device of claim 5, wherein, when the transmission signal, which corresponds to the first display area of the display panel, is received, the driving circuit outputs the data signal, which corresponds to the first display area of the display panel, and
wherein, when the transmission signal, which corresponds to the second display area of the display panel, is received, the driving circuit outputs the data signal, which corresponds to the second display area of the display panel.

7. The electronic device of claim 5, wherein, when an operating mode is changed from the single frequency mode to the multi-frequency mode, the processor outputs the transmission signal, which corresponds to a full image to be displayed on an entire display area of the display panel in a first frame of the multi-frequency mode.

8. The electronic device of claim 7, wherein the driving circuit includes:
a driving controller configured to receive the transmission signal and to output an image data signal and an emission control signal based on the transmission signal; and
a data driving circuit configured to output the data signal, which corresponds to the image data signal to the display panel.

9. The electronic device of claim 8, wherein the driving controller includes:
a counter circuit configured to output a first count signal and a second count signal corresponding to the first display area and the second display area, respectively, in synchronization with the emission control signal, and
wherein, when at least one of the first count signal and the second count signal reaches a preset value, the driving controller transmits the refresh request signal to the processor.

10. The electronic device of claim 9, wherein the driving controller resets the first count signal of the counter circuit to ‘0’ when the transmission signal, which corresponds to the first display area, is received, and resets the second count signal of the counter circuit to ‘0’, when the transmission signal, which corresponds to the second display area, is received.

11. The electronic device of claim 5, wherein when a size of at least one of the first display area and the second display area is changed, the processor outputs the transmission signal, which corresponds to a full image to be displayed on an entire display area of the display panel.

12. An electronic device comprising:
a display panel;
a processor configured to output a transmission signal; and
a driving circuit configured to receive the transmission signal and to output a data signal such that an image is displayed on the display panel based on the transmission signal,
wherein, in a multi-frequency mode, the processor divides the display panel into a first display area, where a still image is displayed, and a second display area, where a video is displayed, and outputs the transmission signal, which corresponds to only the second display area of the first and second display areas,
wherein, in the multi-frequency mode, the driving circuit transmits a refresh request signal to the processor when a display time of the still image displayed in the first display area of the display panel reaches a preset time, and
wherein the processor outputs the transmission signal, which corresponds to a full image to be displayed on the first and second display areas of the display panel in response to the refresh request signal.

13. The electronic device of claim 12, wherein the processor outputs the transmission signal, which corresponds to the full image in a first frame of the multi-frequency mode.

14. The electronic device of claim 13, wherein the driving circuit includes:
a driving controller configured to receive the transmission signal and to output an image data signal and an emission control signal based on the transmission signal; and
a data driving circuit configured to output the data signal, which corresponds to the image data signal to the display panel.

15. The electronic device of claim 14, wherein the driving controller includes:
a counter circuit configured to output a first count signal and a second count signal corresponding to the first display area and the second display area, respectively, in synchronization with the emission control signal, and
wherein, when at least one of the first count signal and the second count signal reaches a preset value, the driving controller transmits the refresh request signal to the processor.

16. The electronic device of claim 15, wherein the driving controller resets the first count signal of the counter circuit to ‘0’ when the transmission signal, which corresponds to the first display area, is received, and resets the second count signal of the counter circuit to ‘0’, when the transmission signal, which corresponds to the second display area, is received.

17. The electronic device of claim 15, wherein when a size of at least one of the first display area and the second display area is changed, the processor outputs the transmission signal, which corresponds to the full image.

18. A driving circuit comprising:
a driving controller configured to receive a transmission signal and to output an image data signal and an emission control signal based on the transmission signal; and
a data driving circuit configured to output a data signal corresponding to the image data signal to a display panel,
wherein the driving controller divides the display panel into a first display area, where a still image is displayed, and a second display area, where a video is displayed, based on the transmission signal, and
wherein, when a display time of the still image reaches a preset time, the driving controller outputs a refresh request signal.

19. The driving circuit of claim 18, wherein the driving controller includes:
a counter circuit configured to output a first count signal and a second count signal corresponding to the first display area and the second display area, respectively, in synchronization with the emission control signal, and
wherein, when at least one of the first count signal and the second count signal reaches a preset value, the driving controller outputs the refresh request signal.

20. The driving circuit of claim 19, wherein the driving controller resets the first count signal of the counter circuit to ‘0’ when the transmission signal, which corresponds to the first display area, is received, and resets the second count signal of the counter circuit to ‘0’, when the transmission signal, which corresponds to the second display area, is received.
